(19) United States
(12) Patent Application Publication
(10) Pub. No.: US 2025/0227807 A1
(43) Pub. Date: Jul. 10, 2025

(54) USER EQUIPMENT BEHAVIOR BASED ON DETECTION OF CELL DISCONTINUOUS OPERATION

(71) Applicant: QUALCOMM Incorporated, San Diego, CA (US)

(72) Inventors: Ahmed Attia ABOTABL, San Diego, CA (US); Diana MAAMARI, San Diego, CA (US)

(21) Appl. No.: 18/405,706

(22) Filed: Jan. 5, 2024

(51) Int. Cl. H04W 76/28

(52) U.S. Cl. CPC H04W 76/28

(57) ABSTRACT

Methods, systems, and devices for wireless communications are described. A user equipment (UE) may report, from a first layer of the UE to a second layer of the UE, a failure to receive an activation message or a deactivation message associated with a cell discontinuous operation in accordance with information differentiating a first communication during active periods of the cell discontinuous operation from a second communication outside of the active periods. The UE may transmit, to a network entity, a message indicating the failure to receive the activation message or the deactivation message. Additionally, or alternatively, the UE may change an activation status of a cell discontinuous transmission (DTX) or discontinuous reception (DRX) configuration at the UE based on the reporting of the failure to receive the activation message or the deactivation message.

### INTRODUCTION

The following relates generally to wireless communications, and more specifically to detection of a cell discontinuous operation.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communications by a UE is described. The method may include reporting, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods and transmitting, to a network entity based on the reporting of the failure to receive the activation message or the deactivation message from the first layer to the second layer, a message indicating the failure to receive the activation message or the deactivation message.

An apparatus for wireless communication at a UE is described. The apparatus may include one or more memories and one or more processors coupled with the one or more memories. The one or more processors may be configured to cause the UE to report, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods and transmit, to a network entity based on the report of the failure to receive the activation message or the deactivation message from the first layer to the second layer, a message indicating the failure to receive the activation message or the deactivation message.

Another apparatus for wireless communication at a UE is described. The apparatus may include means for reporting, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods and means for transmitting, to a network entity based on the reporting of the failure to receive the activation message or the deactivation message from the first layer to the second layer, a message indicating the failure to receive the activation message or the deactivation message.

A non-transitory computer-readable medium storing code for wireless communication at a UE is described. The code may include instructions executable by one or more processors to cause the UE to report, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods and transmit, to a network entity based on the report of the failure to receive the activation message or the deactivation message from the first layer to the second layer, a message indicating the failure to receive the activation message or the deactivation message.

Some examples of the method, UEs, and non-transitory computer-readable medium described herein may further include operations, features, means, or instructions for transmitting, via the message, an indication that the cell discontinuous operation corresponds to cell discontinuous transmission (DTX) or cell discontinuous reception (DRX), or both.

Some examples of the method, UEs, and non-transitory computer-readable medium described herein may further include operations, features, means, or instructions for transmitting, via the message, an indication of a cell DTX or DRX (DTX/DRX) configuration associated with the cell discontinuous operation in accordance with a detection of the cell DTX/DRX configuration from a set of multiple cell DTX/DRX configurations associated with the cell discontinuous operation.

Some examples of the method, UEs, and non-transitory computer-readable medium described herein may further include operations, features, means, or instructions for activating the cell DTX/DRX configuration at the UE in accordance with transmitting the message, the message including a second indication that the cell DTX/DRX configuration may be activated at the UE.

Some examples of the method, UEs, and non-transitory computer-readable medium described herein may further include operations, features, means, or instructions for transmitting, via the message, a second indication that the UE will activate the cell DTX/DRX configuration at the UE after a duration and activating the cell DTX/DRX configuration at the UE after the duration.

Some examples of the method, UEs, and non-transitory computer-readable medium described herein may further include operations, features, means, or instructions for receiving, from the network entity and responsive to the message, a control message indicating to the UE to activate a cell DTX/DRX configuration associated with the cell discontinuous operation and activating the cell DTX/DRX configuration at the UE based on the control message.

Some examples of the method, UEs, and non-transitory computer-readable medium described herein may further include operations, features, means, or instructions for receiving second information indicative of one or more random access channel occasions and a set of multiple random access preambles associated with a misdetection of the activation message or the deactivation message and transmitting the message via a random access channel occasion of the one or more random access channel occasions, the message including a preamble of the set of multiple random access preambles to indicate the failure to receive the activation message or the deactivation message.

Some examples of the method, UEs, and non-transitory computer-readable medium described herein may further include operations, features, means, or instructions for receiving, during a random access response window associated with the random access channel occasion, a control message indicating to the UE to activate a cell DTX/DRX configuration based on the preamble.

In some examples of the method, UEs, and non-transitory computer-readable medium described herein, the set of multiple random access preambles include two or more groups of random access preambles, each of the two or more groups of random access preambles being indicative of a respective set of bits that indicates whether the cell discontinuous operation corresponds to DTX or DRX, that indicate a detected cell DTX/DRX configuration from a set of multiple cell DTX/DRX configurations associated with the cell discontinuous operation, or both.

In some examples of the method, UEs, and non-transitory computer-readable medium described herein, the message indicates that the cell discontinuous operation may be associated with an unknown cell DTX/DRX configuration at the UE.

In some examples of the method, UEs, and non-transitory computer-readable medium described herein, the transmitting may include operations, features, means, or instructions for transmitting the message via a set of resources, the set of resources corresponding to a channel state information report or an uplink configured grant.

A method for wireless communications by a UE is described. The method may include reporting, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods and changing an activation status of a cell DTX/DRX configuration at the UE based on the reporting of the failure to receive the activation message or the deactivation message from the first layer to the second layer.

An apparatus for wireless communication at a UE is described. The apparatus may include one or more memories and one or more processors coupled with the one or more memories. The one or more processors may be configured to cause the UE to report, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods and change an activation status of a cell DTX/DRX configuration at the UE based on the report of the failure to receive the activation message or the deactivation message from the first layer to the second layer.

Another apparatus for wireless communication at a UE is described. The apparatus include means for reporting, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods and means for changing an activation status of a cell DTX/DRX configuration at the UE based on the reporting of the failure to receive the activation message or the deactivation message from the first layer to the second layer.

A non-transitory computer-readable medium storing code for wireless communication at a UE is described. The code may include instructions executable by one or more processors to cause the UE to report, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods and change an activation status of a cell DTX/DRX configuration at the UE based on the report of the failure to receive the activation message or the deactivation message from the first layer to the second layer.

Some examples of the method, UEs, and non-transitory computer-readable medium described herein may further include operations, features, means, or instructions for receiving a message indicating the cell DTX/DRX configuration as a fallback cell DTX/DRX configuration and activating the cell DTX/DRX configuration based on the reporting of the failure to receive the activation message and the cell DTX/DRX configuration being the fallback cell DTX/DRX configuration, the changing of the activation status including the activating of the cell DTX/DRX configuration.

Some examples of the method, UEs, and non-transitory computer-readable medium described herein may further include operations, features, means, or instructions for activating or deactivating the cell DTX/DRX configuration based on a parameter associated with the reporting of the failure to receive the activation message or the deactivation message satisfying a threshold, the changing of the activation status including the activating or the deactivating of the cell DTX/DRX configuration.

In some examples of the method, UEs, and non-transitory computer-readable medium described herein, the parameter may be a counter and the method, apparatuses, and non-transitory computer-readable medium may include further operations, features, means, or instructions for incrementing the counter based on reporting the failure to receive the activation message or the deactivation message, the activating or the deactivating of the cell DTX/DRX configuration based on a value of the counter satisfying the threshold.

In some examples of the method, UEs, and non-transitory computer-readable medium described herein, the parameter may be a timer and the method, apparatuses, and non-transitory computer-readable medium may include further operations, features, means, or instructions for starting the timer based on reporting the failure to receive the activation message or the deactivation message, the activating or the deactivating of the cell DTX/DRX configuration based on an expiration of the timer.

In some examples of the method, UEs, and non-transitory computer-readable medium described herein, the parameter may be a confidence level, and the method, apparatuses, and non-transitory computer-readable medium may include further operations, features, means, or instructions for performing one or more first measurements associated with one or more active periods of the cell DTX/DRX configuration and one or more second measurements associated with one or more non-active periods of the cell DTX/DRX configuration, the activating or the deactivating of the cell DTX/DRX configuration based on the confidence level associated with the one or more first measurements or the one or more second measurements, or both, satisfying the threshold.

A method for wireless communications by a network entity is described. The method may include outputting one or more control messages that include information associated with whether a cell discontinuous operation is activated or deactivated, the cell discontinuous operation being associated with a cycle that includes a set of multiple active periods and a set of multiple non-active periods, the information differentiating a first communication during the set of multiple active periods from a second communication outside of the set of multiple active periods, outputting an activation message or a deactivation message associated with the cell discontinuous operation, and obtaining, from a UE, a message indicating a failure by the UE to receive the activation message or the deactivation message.

An apparatus for wireless communication at a network entity is described. The apparatus may include one or more memories and one or more processors coupled with the one or more memories. The one or more processors may be configured to cause the network entity to output one or more control messages that include information associated with whether a cell discontinuous operation is activated or deactivated, the cell discontinuous operation being associated with a cycle that includes a set of multiple active periods and a set of multiple non-active periods, the information differentiating a first communication during the set of multiple active periods from a second communication outside of the set of multiple active periods, output an activation message or a deactivation message associated with the cell discontinuous operation, and obtain, from a UE, a message indicating a failure by the UE to receive the activation message or the deactivation message.

Another apparatus for wireless communication at a network entity is described. The apparatus may include means for outputting one or more control messages that include information associated with whether a cell discontinuous operation is activated or deactivated, the cell discontinuous operation being associated with a cycle that includes a set of multiple active periods and a set of multiple non-active periods, the information differentiating a first communication during the set of multiple active periods from a second communication outside of the set of multiple active periods, means for outputting an activation message or a deactivation message associated with the cell discontinuous operation, and means for obtaining, from a UE, a message indicating a failure by the UE to receive the activation message or the deactivation message.

A non-transitory computer-readable medium storing code for wireless communication at a network entity is described. The code may include instructions executable by one or more processors to cause the network entity to output one or more control messages that include information associated with whether a cell discontinuous operation is activated or deactivated, the cell discontinuous operation being associated with a cycle that includes a set of multiple active periods and a set of multiple non-active periods, the information differentiating a first communication during the set of multiple active periods from a second communication outside of the set of multiple active periods, output an activation message or a deactivation message associated with the cell discontinuous operation, and obtain, from a UE, a message indicating a failure by the UE to receive the activation message or the deactivation message.

Some examples of the method, network entities, and non-transitory computer-readable medium described herein may further include operations, features, means, or instructions for obtaining, via the message, an indication that the cell discontinuous operation corresponds to cell DTX or cell DRX, or both.

Some examples of the method, network entities, and non-transitory computer-readable medium described herein may further include operations, features, means, or instructions for obtaining, via the message, an indication of a cell DTX/DRX configuration associated with the cell discontinuous operation.

Some examples of the method, network entities, and non-transitory computer-readable medium described herein may further include operations, features, means, or instructions for obtaining, via the message, a second indication that the UE will activate the cell DTX/DRX configuration after a duration.

Some examples of the method, network entities, and non-transitory computer-readable medium described herein may further include operations, features, means, or instructions for outputting, to the UE and responsive to the message, a control message indicating to the UE to activate a cell DTX/DRX configuration associated with the cell discontinuous operation.

Some examples of the method, network entities, and non-transitory computer-readable medium described herein may further include operations, features, means, or instructions for outputting second information indicative of one or more random access channel occasions and a set of multiple random access preambles associated with a misdetection of the activation message or the deactivation message and obtaining the message via a random access channel occasion of the one or more random access channel occasions, the message including a preamble of the set of multiple random access preambles to indicate the failure to receive the activation message or the deactivation message.

Some examples of the method, network entities, and non-transitory computer-readable medium described herein may further include operations, features, means, or instructions for outputting, during a random access response window associated with the random access channel occasion, a control message indicating to the UE to activate a cell DTX/DRX configuration based on the preamble.

In some examples of the method, network entities, and non-transitory computer-readable medium described herein, the set of multiple random access preambles includes two or more groups of random access preambles, each of the two or more groups of random access preambles being indicative of a respective set of bits that indicates whether the cell discontinuous operation corresponds to DTX or DRX, that indicate a detected cell DTX/DRX configuration from a set of multiple cell DTX/DRX configurations associated with the cell discontinuous operation, or both.

In some examples of the method, network entities, and non-transitory computer-readable medium described herein, the message indicates that the cell discontinuous operation may be associated with an unknown cell DTX/DRX configuration at the UE.

In some examples of the method, network entities, and non-transitory computer-readable medium described herein, the receiving may include operations, features, means, or instructions for obtaining the message via a set of resources, the set of resources corresponding to a channel state information report or an uplink configured grant.

### BRIEF DESCRIPTION OF THE DRAWINGS

FIG. 1 shows an example of a wireless communications system that supports UE behavior based on detection of a cell discontinuous operation in accordance with one or more aspects of the present disclosure.

FIG. 2 shows an example of a network architecture that supports UE behavior based on detection of a cell discontinuous operation in accordance with one or more aspects of the present disclosure.

FIG. 3 shows an example of a wireless communications system that supports UE behavior based on detection of a cell discontinuous operation in accordance with one or more aspects of the present disclosure.

FIGS. 4A and 4B show examples of timing diagrams that support UE behavior based on detection of a cell discontinuous operation in accordance with one or more aspects of the present disclosure.

FIG. 5 shows an example of a process flow that supports UE behavior based on detection of a cell discontinuous operation in accordance with one or more aspects of the present disclosure.

FIGS. 6 and 7 show block diagrams of devices that support UE behavior based on detection of a cell discontinuous operation in accordance with one or more aspects of the present disclosure.

FIG. 8 shows a block diagram of a communications manager that supports UE behavior based on detection of a cell discontinuous operation in accordance with one or more aspects of the present disclosure.

FIG. 9 shows a diagram of a system including a device that supports UE behavior based on detection of a cell discontinuous operation in accordance with one or more aspects of the present disclosure.

FIGS. 10 and 11 show block diagrams of devices that support UE behavior based on detection of a cell discontinuous operation in accordance with one or more aspects of the present disclosure.

FIG. 12 shows a block diagram of a communications manager that supports UE behavior based on detection of a cell discontinuous operation in accordance with one or more aspects of the present disclosure.

FIG. 13 shows a diagram of a system including a device that supports UE behavior based on detection of a cell discontinuous operation in accordance with one or more aspects of the present disclosure.

FIGS. 14 through 18 show flowcharts illustrating methods that support UE behavior based on detection of a cell discontinuous operation in accordance with one or more aspects of the present disclosure.

### DETAILED DESCRIPTION

Some wireless communications systems utilize a cell discontinuous operation (e.g., a cell DTX or a cell DRX operation, or both), which may allow one or more devices (e.g., a network entity) to sleep for a duration to conserve power. As described herein, “cell discontinuous operation” may be understood as cell DTX or cell DRX or both. Also, “cell DTX/DRX” may be understood as cell DTX alone, cell DRX alone, or both cell DTX and cell DRX. As part of the cell discontinuous operation, the network entity may (repeatedly) cycle between an active period and a non-active period. An active period may refer to a period that is intended (e.g., allocated, scheduled) for communications (e.g., transmissions or receptions of communication signals) by a network entity, a UE, or other device. A non-active period may refer to a period in which such communications are reduced relative to an active period (e.g., a network entity and/or UE may reduce transmissions and receptions, devices may enter a low power state in which communications are not performed). For example, during the active periods, the network entity may transmit one or more downlink messages or monitor one or more uplink channels for uplink messages. During the non-active periods, the network entity may sleep, enter a low power operation (e.g., enabling power savings at the UE), refrain from transmitting the one or more downlink messages (or otherwise limit, reduce, or constrain downlink transmissions), refrain from monitoring the one or more uplink channels (or otherwise limit, reduce, or constrain uplink communication), or a combination thereof. Accordingly, the cycle between active and non-active periods may enable devices of a wireless communications system (e.g., the network entity, one or more UEs) to operate with relatively lower energy consumption for at least some periods (e.g., during the non-active periods).

Activation and deactivation of cell discontinuous operations may be based on control signaling from a network entity (e.g., via a downlink control information (DCI) message) including an activation message or a deactivation message (activation/deactivation message) (e.g., an activation DCI or a deactivation DCI). As described herein, an “activation message” may refer to a message (e.g., a signal, a communication) that indicates (e.g., to a UE) an activation of a cell discontinuous operation and a “deactivation message” may refer to a message (e.g., a signal, a communication) that indicates deactivation of the cell discontinuous operation. However, a UE (e.g., a UE that may be in a connected mode with the network entity) may miss, or fail to detect (e.g., fail to successfully receive, decode, parse, or any combination thereof), the activation message or deactivation message. In some cases, the UE may identify failed detections of activation messages. However, without proper correction, the UE may continue to operate in accordance with an operation that is out of sync with the network entity, which may result in increased power consumption, increased latency, and decreased efficiency in a wireless communication, among other effects.

In accordance with examples described herein, a UE may report, to a higher layer of the UE, a failed detection (e.g., a misdetection) of an activation/deactivation message. In some implementations, the UE may additionally report (e.g., transmit an indication of) the failed detection to a network entity or may autonomously switch to a cell DTX or DRX (DTX/DRX) configuration that is detected by the UE (e.g., with or without reporting to the network entity). By reporting the failed detection to higher layers of the UE, the higher layers of the UE may perform various corrective actions to realign the UE with a cell DTX/DRX configuration of a network entity, which may improve coordination between the UE and the network entity and may enable energy savings at the UE. A report of the failed detection of the activation/deactivation message may indicate a specific cell DTX/DRX configuration that has been detected by the UE, or the report may indicate that the UE was unable to detect the specific activated DTX/DRX configuration (e.g., that the activated DTX/DRX configuration is unknown, at least to the UE). The report may, additionally, or alternatively, indicate whether the UE has switched to a cell DTX/DRX configuration (e.g., a specific cell DTX/DRX configuration detected by the UE or a fallback cell DTX/DRX configuration). In some examples, the UE may transmit the report of the failed detection of the activation/deactivation message via one or more preambles of a random access occasion (such that a selection of a specific preamble of a set of preambles by the UE conveys some information associated with the failed detection). In some other examples, the UE may transmit the report of the failed detection of the activation/deactivation message via a field (e.g., a set of one or more bits) of a message that the UE transmits to the network entity.

In some examples, the UE may be unable to detect the cell DTX/DRX configuration that is activated, and the UE may autonomously switch to a (preconfigured or preloaded) fallback cell DTX/DRX configuration. In implementations in which the UE autonomously switches to or from a cell DTX/DRX configuration (e.g., to or from a fallback cell DTX/DRX configuration or a specific cell DTX/DRX configuration detected by the UE), the UE may be understood as changing an activation status of the cell DTX/DRX configuration. In other words, changing an activation status of a cell DTX/DRX configuration may be understood as changing the cell DTX/DRX configuration from an activated state to a deactivated state or changing the cell DTX/DRX configuration from a deactivated state to an activated state. As described herein, “cell discontinuous operation” or a “cell discontinuous operation configuration” may be understood as cell DTX or cell DRX or both. Also, “cell DTX/DRX” may be understood as cell DTX alone, cell DRX alone, or both cell DTX and cell DRX. Further, a “cell DTX/DRX configuration” may be understood as a specific example of cell discontinuous operation, with “cell discontinuous operation” referring more generally to operation according to which a network entity reduces, limits, or constrains uplink communication or downlink communication or both.

Additionally, or alternatively, the UE may detect whether a cell DTX/DRX configuration has been activated or deactivated (without a reliance on an activation/deactivation message) in accordance with information (e.g., parameters, configurations, and/or thresholds) that differentiates, or that enables the UE to differentiate, a first communication (e.g., first reference signals, measurements, and/or scheduling messages) within one or more active periods from second communication (e.g., second reference signals, measurements, and/or scheduling messages) within one or more non-active periods (e.g., or other periods outside of the active periods) of the cell discontinuous operation (e.g., of a cell DTX/DRX configuration or operation). In accordance with such information, the UE may report, from a first layer (e.g., a lower layer, such as a physical (PHY) layer) of the UE to a second layer (e.g., a higher layer, such as a Packet Data Convergence Protocol (PDCP), radio link control (RLC), medium access control (MAC), or radio resource control (RRC) layer), an indication of a failure to receive an activation/deactivation message. In accordance with reporting the failure to receive the activation/deactivation message from the first layer to the second layer, the UE may transmit a message (e.g., an uplink message, such as via a physical uplink control channel (PUCCH) or a physical uplink shared channel (PUSCH)) to the network entity (to inform the network entity of the reception failure at the UE) and/or change an activation status of a cell DTX/DRX configuration.

By reporting the failed detection to the network entity or autonomously switching to a cell DTX/DRX configuration, aspects of the present disclosure may support reduced energy consumption, decreased latency, improved device coordination, increased battery life, and increased spectral efficiency. For example, the UE may obtain a greater synchronization with the network entity regarding transmission and reception windows or opportunities, which may reduce a quantity of failed transmissions, thereby reducing latency and reducing power consumption and achieving more consistent or predictable data transfer schedules, which may in turn improve a user experience. Further, the UE may have an increased quantity of opportunities to enter, and/or to remain in, a sleep mode, which may support power savings and increased battery life at the UE, in addition to the network energy savings achieved at the network entity employing cell DTX/DRX. Moreover, by enabling the UE to provide, to the network entity, information pertaining to whether a specific cell DTX/DRX configuration detected and/or pertaining to whether the UE has switched to a detected or fallback cell DTX/DRX configuration, the described techniques may be implemented to realize greater synchronization and coordination between the UE and the network entity, which may result in or otherwise support more reliable and predictable communication between the UE and the network entity. In accordance with such reduced latency, reduced power consumption, and increased battery life, the described techniques may be further implemented to support higher data rates, greater system capacity, and greater spectral efficiency.

Aspects of the disclosure are initially described in the context of wireless communications systems. Aspects of the disclosure are further described in the context of network architectures, wireless communications systems, timing diagrams, and process flows. Aspects of the disclosure are further illustrated by and described with reference to apparatus diagrams, system diagrams, and flowcharts that relate to UE behavior based on detection of a cell discontinuous operation.

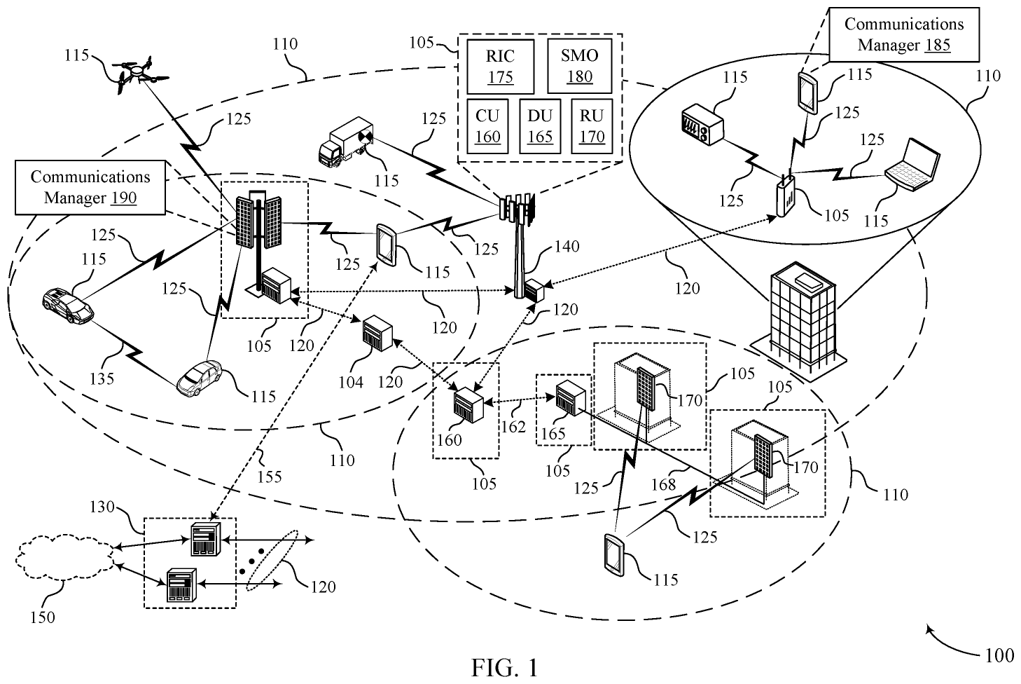

FIG. 1 shows an example of a wireless communications system 100 that supports UE behavior based on detection of a cell discontinuous operation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), PDCP). The CU 160 may be connected to one or more DUs 165 or RUs 170, and the one or more DUs 165 or RUs 170 may host lower protocol layers, such as layer 1 (L1) (e.g., PHY layer) or L2 (e.g., RLC layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support UE behavior based on detection of a cell discontinuous operation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, be mis-aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, such as transmission only or reception only). In some examples, half-duplex communications may be performed at a reduced peak rate. Other power conservation techniques for the UEs 115 include entering a power saving deep sleep mode, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or otherwise refrain from receiving transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information (CSI) reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, a network entity 105 (e.g., a cell of a network entity 105) may support a cell discontinuous DTX operation or a cell DRX operation. The cell DTX operation or the cell DRX operation may support energy savings at the network entity 105. For example, as part of the cell DTX operation, the network entity 105 may cycle between a cell DTX active period and a cell DTX non-active period. During the cell DTX active period, the network entity 105 may transmit one or more downlink messages. During the cell DTX non-active period, the network entity 105 (e.g., or a UE 115) may sleep, enter a low power operation, refrain from transmitting the one or more downlink messages, or a combination thereof.

As part of the cell DRX operation, the network entity 105 may cycle between a cell DRX active period and a cell DRX non-active period. During the cell DRX active period, the network entity 105 may monitor one or more uplink channels, receive one or more uplink messages, or a combination thereof. During the cell DRX non-active period, the network entity 105 (e.g., or a UE 115) may sleep, enter a low power operation, refrain from monitoring the one or more uplink channels or receiving the one or more uplink messages, or a combination thereof. In some examples, the cell DTX operation or the cell DRX operation may support various enhancements that may enable the network entity 105 to stay in a low power operation (e.g., sleep operation) for a longer duration, may enable an increased quantity of opportunities for the network entity 105 to enter a low power operation, or a combination thereof, which may support increased energy savings.

In some examples, a UE 115 may be in an RRC connected operation with the network entity 105, and the network entity 105 may align a cell DRX operation of the UE 115 with a cell DTX/DRX operation of the network entity 105. The network entity 105 may perform inter-node information exchange in accordance with the cell DTX/DRX operation. The network entity 105 may configure enhancements for the cell DTX/DRX operation such that SSB transmission may remain unchanged and such that any impact to idle or inactive UEs 115 may be reduced.

The network entity 105 may activate or deactivate a cell DTX/DRX operation by transmitting an activation/deactivation DCI message. In some examples, the network entity 105 may transmit a group common DCI (e.g., via layer 1 (L1) signaling via a physical downlink control channel (PDCCH)) to multiple UEs 115. In some cases, the group common DCI may be unable to support HARQ feedback (e.g., from a UE 115). The group common DCI message may have a relatively lower reliability than a UE-specific DCI message, which may result in a failure to detect or receive the group common DCI message by one or more of the multiple UEs 115.

A format of the group common DCI message may differ from that of a UE-specific DCI message. For example, a group common DCI message may support a defined DCI format (e.g., DCI format 2_6 for power saving information outside DRX active time) or a new DCI format (e.g., DCI format 2_X). The defined DCI format may be associated with monitoring communications within a cell DRX active time and other field content. The new DCI format may include a field content format. The field content format may include one or more blocks (e.g., block number 1, block number 2, block number N, etc.) for indicating activation or deactivation of a cell DTX/DRX operation, and other field details. In some examples, the blocks may correspond to activation or deactivation of cell DTX/DRX operation at different UEs 115 (e.g., a mapping of a UE 115 and each of the one or more blocks), may differentiate activation or deactivation of a cell DTX operation from activation or deactivation of a cell DRX operation, or a combination thereof. Additionally, or alternatively, a size of the group common DCI may be indicated by higher layers of the network entity 105 and may be associated with an identifier (e.g., a radio network temporary identifier (RNTI)). In some examples, to support a greater reliability of the activation/deactivation message for the cell DTX/DRX operation (e.g., and based on UE capability), the network entity 105 may indicate the activation/deactivation via a MAC-control element (MAC-CE).

During non-active periods of the cell DTX operation, a UE 115 may expect that the network entity 105 may refrain from transmitting one or more signals or via one or more channels. A list of signals and/or channels that the network entity 105 refrains from transmitting during the cell DTX operation may be preconfigured (e.g., at the UE 115, at the network entity 105). In some examples, the network entity 105 may refrain from transmitting periodic or semi-persistent CSI-RSs that are configured for measurement at the UE 115 via a CSI report configuration message during a cell DTX non-active period. The CSI-RSs may be configured with a report quantity field that includes a rank indicator. Other examples of signals or channels that may be limited (such as withheld from transmission) by the network entity 105 during the non-active period of the cell DTX operation may include a PDCCH in a user specific search, a PDCCH in a type-3 common search space, a positioning reference signal, a CSI-RS configured by for radio resource management, a CSI-RS for radio link monitoring and/or beam failure detection, a periodic CSI-RS for tracking (e.g., tracking of a UE 115), a periodic or semi-persistent CSI-RS for beam management, or a combination thereof. A PDCCH in a user specific search or in a type-3 common search space may be associated with a behavior of a UE 115 for retransmission and may include a specific RNTI scrambled PDCCH or may exclude the specific RNTI (e.g., may be excluded from a cell DTX operation). A periodic or semi-persistent CSI-RS for beam management may be differentiated from other CSI-RSs used for CSI reports (e.g., for beam management).

During non-active periods of the cell DRX operation, the UE 115 may refrain from transmitting some signals or channels. A list of signals and/or channels that the UE 115 refrains from transmitting during the cell DRX operation may be preconfigured at the UE 115. In some examples, the UE 115 may refrain from transmitting a periodic or semi-persistent CSI report or may refrain from transmitting a periodic or semi-persistent sounding reference signal (SRS) (e.g., for positioning). Additionally, or alternatively, the UE 115 may refrain from transmitting HARQ feedback for a semipersistent physical downlink shared channel (PDSCH). In some cases, a UE 115 may support a same or a different behavior based on whether cell DTX/DRX is activated or deactivated. In some cases, the list of signals or channels that are withheld from communication during non-active periods of cell DTX/DRX may be configured (e.g., by a network entity 105). In some cases, there may be exception cases for a UE 115 receiving or processing the listed signals or channels during the non-active periods of cell DTX/DRX. In some cases, an impact on the wireless communications system 100 may be considered if the list of signals or channels are withheld from communication during the non-active periods of cell DTX/DRX.

In some examples, a UE 115 (e.g., a communications manager 185 of the UE 115) may report, from a first layer of the UE 115 (e.g., PDCP, RLC, MAC, RRC, PHY) to a second layer of the UE 115 (e.g., PDCP, RLC, MAC, RRC, PHY), a failure to receive an activation/deactivation message associated with a cell discontinuous operation (e.g., cell DTX/DRX) in accordance with information differentiating a first communication during a set of multiple active periods of the cell discontinuous operation from a second communication outside of the set of multiple active periods. The cell discontinuous operation may be associated with a cycle that includes the set of multiple active periods and a set of multiple non-active periods. The UE 115 (e.g., via or in accordance with the communications manager 185) may transmit, to a network entity 105 based on the reporting of the failure to receive the activation/deactivation message, a message indicating the failure to receive the activation/deactivation message. Additionally, or alternatively, the UE 115 (e.g., via or in accordance with the communications manager 185) may change an activation status of a cell DTX/DRX configuration at the UE 115 based on the reporting of the failure to receive the activation/deactivation message.

Additionally, or alternatively, a network entity 105 (e.g., via or in accordance with a communications manager 190 of the network entity 105) may output one or more control messages that include information associated with whether a cell discontinuous operation is activated or deactivated. The information may differentiate a first communication during a set of multiple active periods of the cell discontinuous operation from a second communication outside of the set of multiple active periods. The cell discontinuous operation may be associated with a cycle that includes the set of multiple active periods and a set of multiple non-active periods. The network entity 105 (e.g., via or in accordance with the communications manager 190) may output an activation message or a deactivation message associated with the cell discontinuous operation and may obtain, from the UE 115, a message indicating a failure by the UE 115 to receive the activation message or the deactivation message.

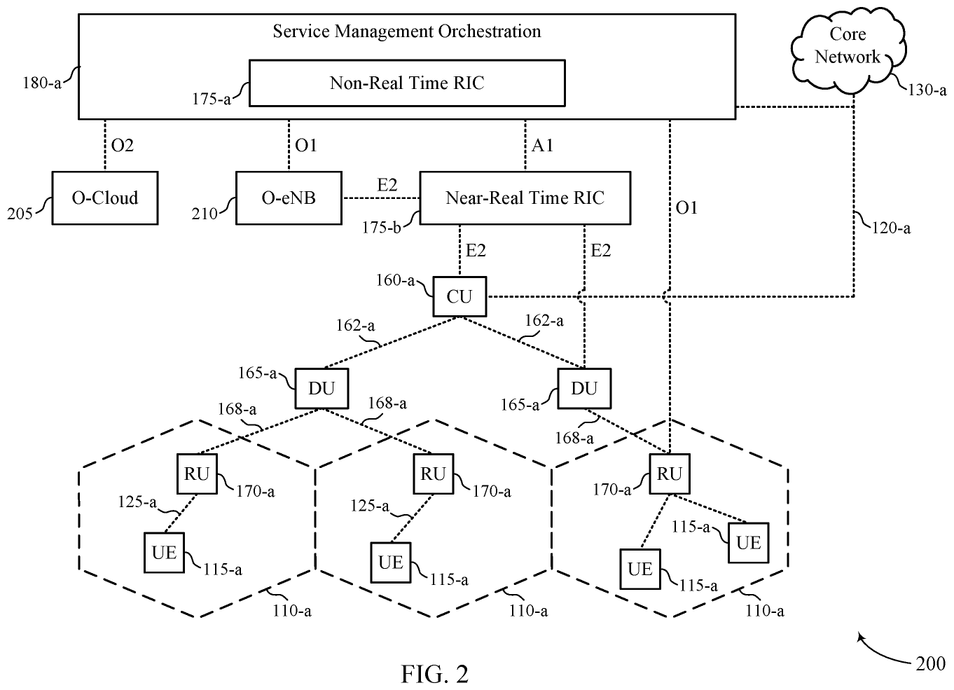

FIG. 2 shows an example of a network architecture 200 (e.g., a disaggregated base station architecture, a disaggregated RAN architecture) that supports UE behavior based on detection of a cell discontinuous operation in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In some examples, a UE 115-a may report, from a first layer of the UE 115-a to a second layer of the UE 115-a, a failure to receive an activation/deactivation message associated with a cell discontinuous operation (e.g., DTX/DRX) in accordance with information differentiating a first communication during a set of multiple active periods of the cell discontinuous operation from a second communication outside of the set of multiple active periods. The cell discontinuous operation may be associated with a cycle that includes the set of multiple active periods and a set of multiple non-active periods. The UE 115-a may transmit, to a network entity 105 (e.g., CU 160-a, DU 165-a, RU 170-a, Non-RT RIC 175-a, Near-RT RIC 175-b, SMO 180-a, O-Cloud 205, O-eNB 210) based on the reporting of the failure to receive the activation/deactivation message, a message indicating the failure to receive the activation/deactivation message. Additionally, or alternatively, the UE 115-a may change an activation status of a cell DTX/DRX configuration at the UE 115-a based on the reporting of the failure to receive the activation/deactivation message.

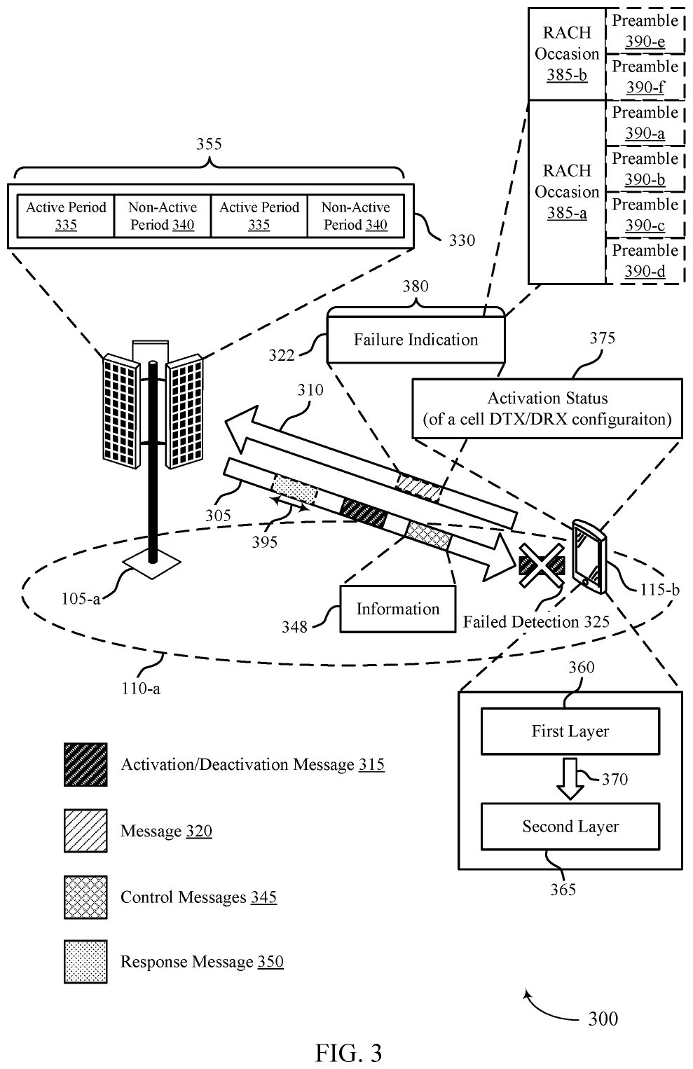

FIG. 3 illustrates an example of a wireless communications system 300 that supports UE behavior based on detection of a cell discontinuous operation. The wireless communications system 300 may implement or be implemented by aspects of the wireless communications system 100 or the network architecture 200 as described with reference to FIGS. 1 and 2. For example, the wireless communications system 300 may include a network entity 105-a and a UE 115-b, which may be examples of, or include network entities 105, UEs 115, CUs 160, DUs 165, RUs 170, network nodes, or other devices as described with reference to FIGS. 1 and 2. The network entity 105 may be associated with a coverage area 110-a (e.g., a cell) that includes one or more UEs 115 including the UE 115-b.

The network entity may communicate with the UE 115-b via a communication link 305 and a communication link 310. The communication link 305 and the communication link 310 may be examples of or include downlink communication interfaces, uplink communication interfaces, or other communication interfaces. For example, the network entity 105-a may communicate downlink signaling (e.g., PDCCH messages, PDSCH messages, activation/deactivation messages 315, control messages 345, or other messages) to the UE 115-b via the communication link 305. The UE 115-b may communicate uplink signaling (e.g., PUCCH messages, PUSCH messages, a message 320, a failure indication 322). Although a network entity 105-a and a UE 115-b are shown, the techniques herein may be applied by one or more other devices described herein, including with reference to FIGS. 1 and 2.

In some cases, the network entity 105-a may operate in accordance with a cell discontinuous operation 330, where the network entity 105-a (e.g., and one or more UEs 115) may enter a reduced activity state for some periods to reduce power consumption and reduce communication traffic. For example, the cell discontinuous operation 330 may be associated with a cycle 355 of active periods 335 and non-active periods 340. During the non-active periods, the network entity 105-a and the UE 115-b may enter the reduced activity state (e.g., a low power mode) to save power. The cell discontinuous operation 330 may be a cell DTX operation, where the network entity 105-a may reduce (e.g., or pause) transmission activity during non-active periods 340. Additionally, or alternatively, the cell discontinuous operation 330 may be a cell DRX operation, where the network entity 105-a may reduce (e.g., or pause) reception activity during non-active periods 340. In some cases, the network entity 105-a may indicate an activation (e.g., or a deactivation) of a cell discontinuous operation 330 via control signaling to one or more UEs 115 in the coverage area 110-a. For example, the network entity 105-a may transmit one or more activation/deactivation messages 315 (e.g., DCI message, group common DCI signaling, activation DCI message, deactivation DCI message) to the UE 115-b that indicates an activation of a cell discontinuous operation 330 or a deactivation of cell discontinuous operation 330.

However, in some cases, the UE 115-b may fail to detect (e.g., fail to receive, missed detection) an activation/deactivation message 315 (e.g., group common DCI signaling for cell DTX/DRX indication), and thus the UE 115-b may not be enabled to save power during the cell discontinuous operation. Additionally, the wireless communications system 300 may refrain from implementing a feedback mechanism (e.g., HARQ feedback) associated with an activation/deactivation message 315 (e.g., for group common signaling). A failed detection 325 of the activation/deactivation message 315 (e.g., a cell discontinuous operation activation/deactivation message 315, a cell DTX/DRX group common DCI) may impact operations of the UE 115-b, the network entity 105-a, or both (e.g., with non-negligible side impact). For instance, the UE 115-b may perform operations (e.g., CSI operations, beam management (BM), radio link monitoring (RLM), radio resource management (RRM), loop operations, or other operations) during non-active periods 340 of the cell discontinuous operation 330 (e.g., when downlink signaling is turned off during cell DTX inactive time). That is, the UE 115-b may consume energy (e.g., waste power) to monitor downlink signals (e.g., PDCCH signals) during the non-active periods 340, even though the network entity 105-a (e.g., a gNB) may refrain from transmitting (or otherwise at least partially limit or constrain) downlink signals. Moreover, the network entity 105-a may perform one or more operations (e.g., SRS measurement, PRACH monitoring) during a non-active period 340 of a cell discontinuous operation 330 (e.g., cell DRX) based on the failed detection 325.

Thus, the wireless communications system 300 may experience various adverse effects based on the failed detection 325 for the activation/deactivation message 315. In some cases, a network entity 105-a may transmit multiple repetitions of an activation/deactivation message 315 to increase a likelihood of detection of the activation/deactivation message 315 (e.g., by the UE 115-b). However, repetition of the activation/deactivation message 315 may consume more energy at the network entity 105-a (e.g., based on repeated transmissions) and at the UE 115-b (e.g., based on an increased quantity of blind decoding attempts). Moreover, although the activation/deactivation message 315 may be repeated, the UE 115-b may still fail to detect the activation/deactivation message 315. Thus, mechanisms that enable a UE 115-b to detect whether the network entity 105 activated a cell discontinuous operation 330 (e.g., detection of a missed activation/deactivation message 315, detection of a failed detection 325) may improve cell discontinuous operations 330 in the wireless communications system 300.

If a UE 115-b detects a failed detection 325 (e.g., a missed activation/deactivation message 315), the UE 115-b may be enabled to utilize recovery mechanisms to resynchronize with the network entity 105-a (e.g., the UE 115-b may adjust a configuration to communicate with the network entity 105-a accordingly) and decrease potential latency. For instance, if the UE 115-b detects a failed detection 325, the UE 115-b may operate in accordance with the cell discontinuous operation 330 (e.g., may assume cell DTX/DRX activation) without receiving an indication from the network entity 105-a. Additionally, or alternatively, the UE 115-b may transmit a message 320 (e.g., an uplink message, such as a PUCCH message or a PUSCH message, such as via uplink control information (UCI) or an uplink data message) including a failure indication 322 to the network entity 105-a (e.g., the UE 115-b may report the missed detection of the activation/deactivation message 315). In other words, the UE 115-b may transmit, to the network entity 105-a, a message 320 indicating the failure to receive the activation/deactivation message 315. Accordingly, mechanisms to support detection of a failed detection 325 of an activation/deactivation message 315 may be beneficial for the wireless communications system 300.

In some examples, a UE 115-b may identify (e.g., be configured to identify) the failed detection 325 of an activation/deactivation message 315 associated with a cell discontinuous operation 330 (e.g., a cell DTX/DRX operation at the network entity 105-a), which may allow the UE 115-b to autonomously recover from the failed detection 325. In some examples, the UE 115-b may receive one or more control messages 345 (e.g., RRC messages, MAC-CE messages, DCI messages, or other control signaling) that include information 348 (e.g., parameters, configurations, thresholds) that differentiates, or that enables the UE 115-b to differentiate, a first communication (e.g., reference signals, measurements, scheduling messages) within one or more active periods 335 from second communication (e.g., reference signals, measurements, scheduling messages) within one or more non-active periods 340 (e.g., or other periods outside of the active periods 335) of the cell discontinuous operation 330 (e.g., of a cell DTX/DRX operation). In some examples, the information 348 may differentiate between a cell discontinuous operation 330 and an absence of the cell discontinuous operation 330 (e.g., a non-DTX/DRX operation). In some examples, the UE 115-b may indicate, via a report 370, the failed detection 325 to higher layers of the UE 115-b. For example, the UE 115-b may report, via the report 370, from a first layer 360 of the UE 115-b to a second layer 365 of the UE 115-b, the failed detection 325 in accordance with the information 348 that differentiates the first communication from the second communication. The first layer 360 or the second layer 365 may be any of a PDCP layer, an RLC layer, a MAC layer, an RRC layer, or a PHY layer, among other examples.

In accordance with techniques described herein, the UE 115-b may, based on the failed detection 325, report the failed detection 325 to the network entity 105-a via the failure indication 322. Additionally, or alternatively, the UE 115-b may, based on the failed detection 325, change an activation status 375 of (e.g., activate, deactivate) a cell DTX/DRX configuration at the UE 115-b. For example, the UE 115-b may autonomously switch to (e.g., activate) a cell DTX/DRX configuration different from a configuration (e.g., another DTX/DRX configuration or a non-DTX/DRX operation) that the UE 115-b is currently operating in. In some cases, the UE 115-b may detect a configuration of a cell DTX/DRX operation that is activated at the network entity 105-a, and the UE 115-b may autonomously switch to the activated cell DTX/DRX configuration. In such cases, the UE 115-b may switch without reporting switching of the activation status 375 to the network entity 105-b, or the UE 115-b may switch and report the switching of the activation status 375 to the activated DTX/DRX configuration to the network entity 105-a via the failure indication 322.

In other cases, the UE 115-b may detect a failure (e.g., the failed detection 325), but the UE 115-b may fail to detect which DTX/DRX configuration is activated at the network entity 105-a. In such cases, the UE 115-b may report, via the failure indication 322, that the UE 115-b failed to identify which DTX/DRX configuration is activated at the network entity 105-a (e.g., that the cell DTX/DRX configuration associated with the failed detection 325 is unknown). Additionally, or alternatively, the UE 115-b may receive, from the network entity 105-a via the one or more control messages 345 or some other message (e.g., an RRC message), an indication of a fallback DTX/DRX configuration. The indication of the fallback DTX/DRX configuration may indicate for the UE 115-b to switch to (e.g., change the activation status 375 to) the fallback DTX/DRX configuration. The UE 115-b may, based on the failed detection 325, switch to (e.g., activate) the fallback DTX/DRX configuration. The fallback DTX/DRX configuration may partially overlap (e.g., one more active periods and/or one or more non-active periods may partially overlap) with the cell DTX/DRX configuration that is activated at the network entity 105-a. The fallback DTX/DRX configuration may include one or more transmission opportunities for transmission of uplink messages at the UE 115-b, one or more reception opportunities for reception of downlink messages at the UE 115-b, one or more non-active periods enabling the UE 115-b and/or the network entity 105-a to enter a low power mode, or a combination thereof.

The UE 115-b may transmit the failure indication 322 in pre-configured resources 380 that are configured (e.g., by the network entity 105-a) for reporting of one or more failure indications 322. For example, the UE 115-b may transmit the failure indication 322 via a configured grant (e.g., uplink configured grant), or the UE 115-b may multiplex the failure indication 322 with one or more CSI reports. In some examples, the network entity 105-a may indicate a set of resources 380 associated with the failure indication 322 via the one or more control messages 345. In some examples, the UE 115-b may transmit the message 320 (including the failure indication 322) via a PRACH, via UCI, or via a higher layer indication (e.g., RRC message, MAC-CE).

The failure indication 322 may include an indication that the failed detection 325 is a detection of a cell DTX operation, or a cell DRX operation, or both. For example, the failure indication 322 may indicate that the cell discontinuous operation associated with the failed detection 325 corresponds to cell DTX or cell DRX, or both. In some examples, the failure indication 322 may indicate a configuration of cell DTX/DRX (e.g., a hypothesis DTX/DRX configuration) that the UE 115-b has detected as being activated at the network entity 105-a. The UE 115-b may detect the activated DTX/DRX configuration from a set of DTX/DRX configurations associated with cell DTX/DRX, and the UE 115-b may report the activated DTX/DRX configuration to the network entity 105-a. The failure indication 322 may indicate that the UE 115-b has switched to the activated DTX/DRX configuration. In some other examples, the UE 115-b may indicate, via the failure indication 322, that the UE 115-b will switch to (e.g., activate) the activated DTX/DRX configuration after a duration (e.g., an application delay).

In some other examples, the UE 115-b may indicate that the UE 115-b will not switch configurations (e.g., will remain in a non-DTX/DRX operation or another DTX/DRX configuration) unless otherwise indicated by the network entity 105-a (e.g., via a response message 350). The UE 115-b may monitor for (e.g., may expect) the response message 350, and the response message 350 may activate a cell DTX/DRX configuration (e.g., the activated DTX/DRX configuration) at the UE 115-b in response to the failure indication 322. The network entity 105-a may transmit the response message 350 via a DCI message (e.g., activation DCI, deactivation DCI, group common DCI), a MAC-CE, or a higher layer indication (e.g., RRC message).

The UE 115-b may receive, via the one or more control messages 345, a configuration of a set of random access channel (RACH) occasions 385 (e.g., a RACH occasion 385-a, a RACH occasion 385-b) and a set of random access preambles 390 (e.g., a preamble 390-a, a preamble 390-b, a preamble 390-c, a preamble 390-d, a preamble 390-e, a preamble 390-f) that are to be monitored by the network entity 105-a regardless of the cell DTX/DRX status (e.g., during both cell DTX/DRX operations and non-DTX/DRX operations). The set of RACH occasions 385 and the set of random access preambles 390 may be associated with (e.g., configured for) a misdetection of an activation/deactivation message 315 (e.g., the failed detection 325). Based on detection of a cell DTX/DRX activation (e.g., the failed detection 325), the UE 115-b may transmit, via the failure indication 322, a preamble 390 (e.g., a preamble 390-a, a preamble 390-b, a preamble 390-c, or a preamble 390-d) of the set of preambles 390 in at least one RACH occasion 385-a of the set of RACH occasions 385. The preamble 390 included in the failure indication 322 may indicate the failed detection 325, may indicate one or more parameters of the failed detection 325, or both. For example, the preamble 390 may indicate that the failed detection 325 corresponds to cell DTX, cell DRX, or both, may indicate an activated DTX/DRX configuration that the UE 115-b detects, or a combination thereof.

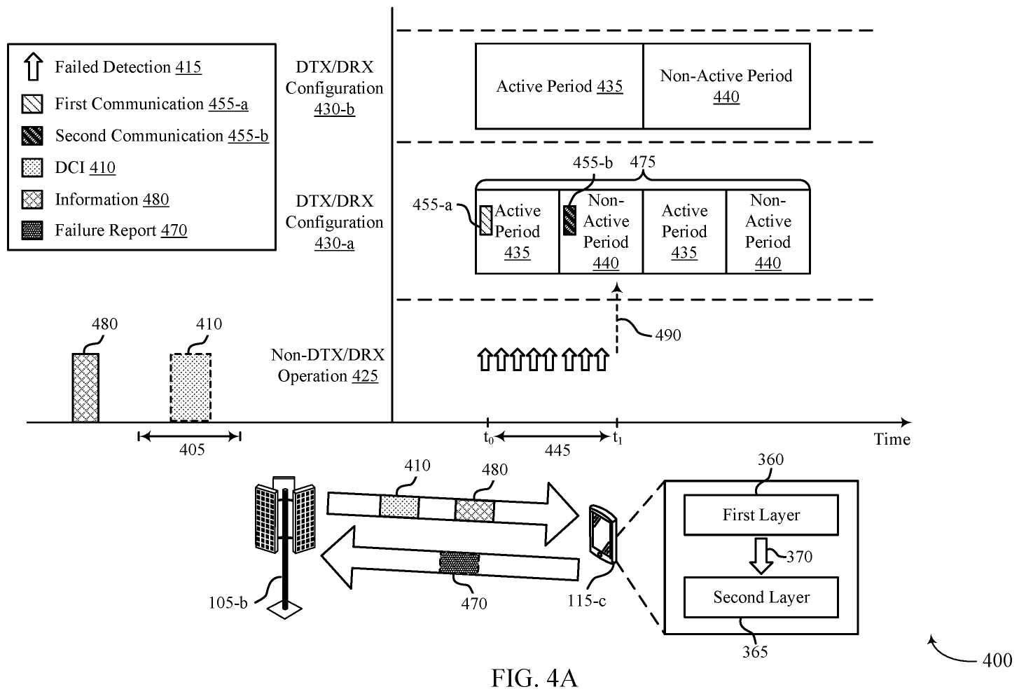

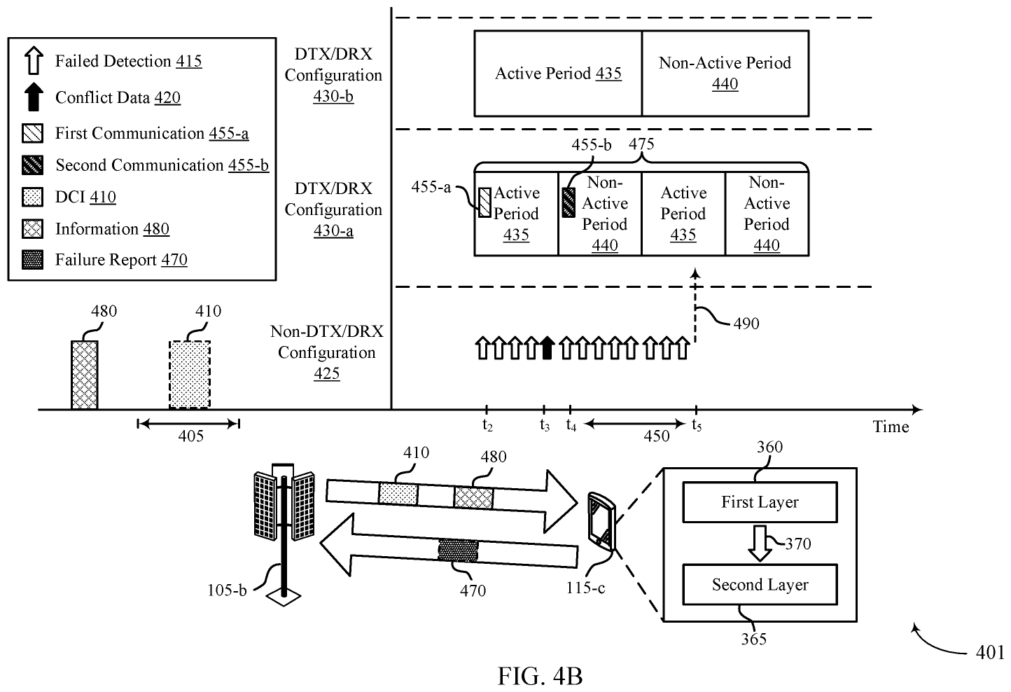

For example, the preamble 390-a may indicate that the failed detection 325 corresponds to cell DTX, the preamble 390-b may indicate that the failed detection 325 corresponds to cell DRX, the preamble 390-c may indicate that the failed detection 325 corresponds to both cell DTX and cell DRX, and the preamble 390-d may indicate that the failed detection 325 corresponds to neither cell DTX or cell DRX, or that such information is unknown by the UE 115-b. Additionally, or alternatively, the preamble 390-a may indicate that the failed detection 325 corresponds to a first cell DTX/DRX configuration (e.g., a DTX/DRX configuration 430-a, as described with reference to FIG. 4A), the preamble 390-b may indicate that the failed detection 325 corresponds to a second cell DTX/DRX configuration (e.g., a DTX/DRX configuration 430-b, as described with reference to FIG. 4A), and the preamble 390-c may indicate that the failed detection corresponds to a cell DTX/DRX configuration that is unknown by the UE 115-b (e.g., may indicate that the UE 115-b is unable to detect the cell DTX/DRX configuration).

In some examples, the set of preambles 390 corresponding to the set of RACH occasions 385 may be partitioned into groups, and a selection of a preamble by the UE 115-b from one of the groups may indicate one or more bits of information. Accordingly, the UE 115-b may transmit, via the failure indication 322, a random access preamble 390, and one or more information bits corresponding to the random access preamble 390 (e.g., which may be preconfigured at the UE 115-b and at the network entity 105-a) may indicate whether the failed detection 325 is for cell DTX, cell DRX, or both, which DTX/DRX configuration the UE 115-b has detected, or a combination thereof. In some examples, the UE 115-b may transmit one or more repetitions of the random access preamble 390 via the failure indication 322.

In some examples, the network entity 105-a may indicate, via the response message 350, a group common or UE specific indication in a random access response window 395 to give information about the activation or deactivation of a cell DTX/DRX operation at the network entity 105-a. The random access response window 395 may correspond to a random access preamble 390 (e.g., the random access preamble 390-a) that is included in the failure indication 322. In some examples, the response message 350 may indicate the UE 115-b to activate a cell DTX/DRX configuration based on the random access preamble 390 that the UE 115-b transmitted via the failure indication 322.

FIGS. 4A and 4B show examples of a timing diagram 400 and a timing diagram 401 that support UE behavior based on detection of a cell discontinuous operation in accordance with one or more aspects of the present disclosure. The timing diagram 400 may implement or be implemented by aspects of the wireless communications system 100, the network architecture 200, or the wireless communications system 300 as described with reference to FIGS. 1, 2, and 3. For example, the timing diagram 400 may include a DCI 410, which may be an example of an activation/deactivation message 315, a cell DTX/DRX configuration 430 (e.g., including one or more active periods 435 and one or more non-active periods 440), which may be an example of or correspond to a cell discontinuous operation 330, and one or more failed detections 415, which may be examples of a failed detection 325, as described with reference to FIG. 3. The timing diagram 400 may include a UE 115-c and a network entity 105-b, which may be examples of, or include network entities 105, UEs 115, CUs 160, DUs 165, RUs 170, network nodes, or other devices as described with reference to FIGS. 1 and 2.

In some cases, the network entity 105-b may operate in accordance with a cell discontinuous operation (e.g., a cell DTX/DRX configuration 430-a, a cell DTX/DRX configuration 430-b), where the network entity 105-b (e.g., and one or more UEs 115) may enter a reduced activity state for some periods to reduce power consumption and reduce communication traffic. For example, the cell DTX/DRX configuration 430-a may be associated with a cycle 475 of active periods 435 and non-active periods 440. During the non-active periods, the network entity 105-b and the UE 115-c may enter the reduced activity state (e.g., a low power mode) to save power. The cell DTX/DRX configuration 430-a may be a cell DTX operation, where the network entity 105-b may reduce (e.g., or pause) transmission activity during non-active periods 440. Additionally, or alternatively, the cell DTX/DRX configuration 430-a may be a cell DRX operation, where the network entity 105-a may reduce (e.g., or pause) reception activity during non-active periods 440. In some cases, the network entity 105-b may indicate an activation (e.g., or a deactivation) of a cell DTX/DRX configuration 430 via control signaling to a UE 115-c. For example, the network entity 105-b may transmit one or more activation/deactivation messages via a DCI 410 (e.g., DCI message, group common DCI signaling, activation DCI message, deactivation DCI message) to the UE 115-c that indicates an activation of a cell DTX/DRX configuration 430 or a deactivation of a cell DTX/DRX configuration 430.

A UE 115-c may be configured, by a network entity 105-b, with an activation DCI window 405, and the UE 115-c may monitor for the DCI 410 during the activation DCI window 405. The DCI 410, which may be transmitted by the network entity 105-b, may indicate for the UE 115-c to activate a cell DTX/DRX configuration 430 (e.g., a cell DTX/DRX configuration 430-a, a cell DTX/DRX configuration 430-b) at the UE 115-c. In some examples, the activation DCI window 405 may be during a non-DTX/DRX operation 425 (e.g., an assumed or expected absence of cell DTX/DRX) at the UE 115-c. As described in greater detail with reference to FIG. 3, the UE 115-c may fail to detect (e.g., fail to receive, missed detection of) the DCI 410, and the UE 115-c may report, via a report 370, one or more failed detections 415 to higher layers of the UE 115-c. For example, the UE 115-c may report the one or more failed detections 415 from a first layer 360 of the UE 115-c to a second layer 365 of the UE 115-c. In some examples, the one or more failed detections 415 may be based on information 480, that the UE 115-c may receive from the network entity 105-b, that differentiates a first communication 455-a during the one or more active periods 435 from a second communication 455-b outside of the one or more active periods 435 (e.g., during one or more non-active periods 440).

In some examples, the UE 115-c may transmit a failure report 470 based on, or in response to, the one or more failed detections 415. Additionally, or alternatively, the UE 115-c may activate or deactivate (e.g., autonomously switch to, perform a switch 490 to) the cell DTX/DRX configuration 430-a based on the one or more failed detections 415. For example, the UE 115-c may detect that the cell DTX/DRX configuration 430-a is activated at the network entity 105-b, and the UE 115-c may activate the detected cell DTX/DRX configuration 430-a, in some cases without indication from the network entity 105-b. By activating the DTX/DRX configuration 430-a, the UE 115-c may perform a switch 490 from the non-DTX/DRX operation 425 to the cell DTX/DRX configuration 430-a. In some examples, activation of the detected cell DTX/DRX configuration 430-a at the UE 115-c (e.g., the switch 490) may be based on a parameter associated with the one or more reported failed detections 415 satisfying a threshold. For example, the UE 115-c may determine that a confidence of the UE 115-c in detecting the cell DTX/DRX configuration 430-a exceeds a threshold.

In some examples, the UE 115-c may activate the detected cell DTX/DRX configuration 430-a based on a quantity of failed detections 415 (e.g., which may be reported from a lower layer of the UE 115-c, for example from the first layer 360 to the second layer 365, via the report 370) satisfying (e.g., exceeding) a threshold during a time window (e.g., a duration 445, a duration 450). In FIG. 4A, the UE 115-c may receive, or identify, a failed detection 415 at t₀. The UE 115-c may increment a counter based on the failed detection 415. At t₁, a value of the counter may be eight (e.g., corresponding to eight failed detections 415 during the duration 445). The value of the counter may exceed the threshold, and the UE 115-c may, at t₁, activate the cell DTX/DRX configuration 430-a at the UE 115-c (e.g., may perform the switch 490 from the non-DTX/DRX operation 425 to the cell DTX/DRX configuration 430-a) based on the value of the counter.

In FIG. 4B, the counter may, at t₃, have a value of four corresponding to four failed detections 415 prior to t₂. However, at t₃, the UE 115-c may receive (e.g., from a lower layer of the UE 115-c), or identify, conflict data 420. The conflict data 420 may include one or more measurements, observations, or other data that contradicts the failed detection 415. In some cases, the conflict data 420 may indicate that the network entity 105-b is operating in a cell DTX/DRX configuration 430 (e.g., the cell DTX/DRX configuration 430-b) different than the cell DTX/DRX configuration 430-a, may indicate that the network entity 105-b is operating in the non-DTX/DRX operation 425, or may indicate that the network entity 105-b is operating in some other configuration. Based on the conflict data 420, the UE 115-c may reset the counter (e.g., to zero). At t₄, the UE 115-c may increment the counter based on the failed detection 415. At t₅, the value of the counter may be eight (e.g., corresponding to eight failed detections 415 during the duration 445). The value of the counter may exceed the threshold, and the UE 115-c may, at t₅, activate the cell DTX/DRX configuration 430-a at the UE 115-c (e.g., may perform the switch 490 from the non-DTX/DRX operation 425 to the cell DTX/DRX configuration 430-a) based on the value of the counter. A threshold of eight failed detections 415 may be an example threshold, and any other threshold or quantity may also be used. The threshold may be configured at the UE 115-c via DCI (e.g., the DCI 410), an RRC message, a MAC-CE, or other signaling.

In some other examples, the UE 115-c may activate the detected cell DTX/DRX configuration 430-a based on an elapsed duration (e.g., the duration 445, the duration 450) after a failed detection 415 without a presence of conflict data 420 (e.g., any interruption or contradicting observation). Additionally, or alternatively, the UE 115-c may activate the detected cell DTX/DRX configuration 430-a based on an expiration of a timer. In FIG. 4A, the UE 115-c may, at t₀, start a timer based on a failed detection 415 (e.g., from a lower layer of the UE 115-c). The timer may be configured with, or initialized to, the duration 445. At t₁, after the duration 445 has elapsed and/or the timer has expired, the UE 115-c may activate the cell DTX/DRX configuration 430-a at the UE 115-c (e.g., may perform the switch 490 from the non-DTX/DRX operation 425 to the cell DTX/DRX configuration 430-a) based on the duration 445 elapsing and/or the timer expiring without presence of conflict data 420.

In FIG. 4B, the UE 115-c may, at t₂, start a timer based on a failed detection 415 (e.g., from a lower layer of the UE 115-c). The timer may be configured with, or initialized to, the duration 450. At t₃, the UE 115-c may receive (e.g., from a lower layer of the UE 115-c, for example via the report 370 from the first layer 360 to the second layer 365) conflict data 420. Based on the conflict data 420, the UE 115-c may pause the timer, reset the timer (e.g., reinitialize the timer to the duration 450), or both. At t₄, the UE 115-c may restart the timer based on another failed detection 415. At t₅, after the duration 450 has elapsed and/or the timer has expired, the UE 115-c may activate the cell DTX/DRX configuration 430-a at the UE 115-c (e.g., may perform the switch 490 from the non-DTX/DRX operation 425 to the cell DTX/DRX configuration 430-a) based on the duration 450 elapsing and/or the timer expiring without presence of conflict data 420. The duration 445, or the duration 450, or both, may be configured at the UE 115-c via DCI (e.g., the DCI 410), an RRC message, a MAC-CE, or other signaling.

In some other examples, the UE 115-c may activate the detected cell DTX/DRX configuration 430-a based on one or more measurements associated with a hypothesis of the cell DTX/DRX configuration 430-a. For example, the UE 115-c may perform one or more first measurements (e.g., based on the first communication 455-a) during an active period 435 of the cell DTX/DRX configuration 430-a and one or more second measurements (e.g., based on the second communication 455-b) during a non-active period 440. The UE 115-c may perform a statistical hypothesis testing procedure on the one or more first measurements and the one or more second measurements. The UE 115-c may activate the detected cell DTX/DRX configuration 430-a based on a difference between the one or more first measurements and the one or more second measurements satisfying a threshold. Additionally, or alternatively, one or more confidence levels (e.g., confidence intervals) associated with the one or more first measurements or the one or more second measurements, or both, may satisfy the threshold. The threshold for the difference in measurements, or for the confidence interval, or both, may be configured at the UE 115-c via DCI (e.g., the DCI 410), an RRC message, a MAC-CE, or other signaling.

The UE 115-c may perform the one or more first measurements and the one or more second measurements based on one or more communications 455 with the network entity 105-b. For example, the network entity 105-b may transmit a first communication 455-a (e.g., a reference signal, a reference signal corresponding to a reference signal identifier) in an active period 435, and the UE 115-c may receive the first communication 455-a from the network entity 105-b. In some aspects, the network entity 105-b may refrain from transmitting a first communication 455-a (e.g., when the cell DTX operation is activated) in a non-active period 440. To detect whether a cell DTX/DRX configuration has been activated or deactivated, the UE 115-c may perform a first measurement for the first communication 455-a (e.g., may measure an RSRP of the reference signal) within the active period 435 and may perform a second measurement for a second communication 455-b (e.g., for a reference signal that the UE 115-c expects to receive but that is withheld from transmission by the network entity 105-b) within a non-active period 440.

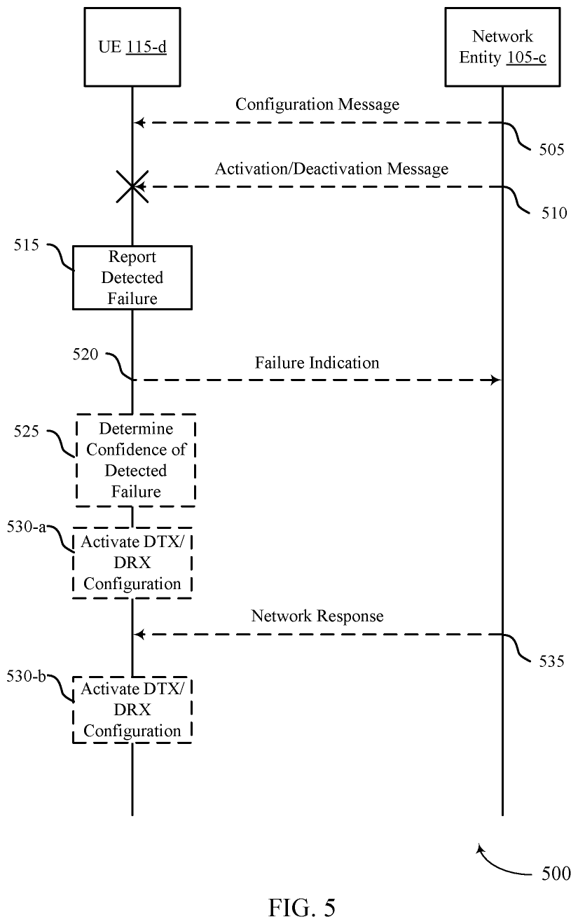

FIG. 5 shows an example of a process flow 500 that supports UE behavior based on detection of a cell discontinuous operation in accordance with one or more aspects of the present disclosure. The process flow 500 may implement or be implemented by aspects of the wireless communications system 100 or the network architecture 200 as described with reference to FIGS. 1 and 2. For example, the process flow 500 may include a network entity 105-c and a UE 115-d, which may be examples of, or include network entities 105, UEs 115, CUs 160, DUs 165, RUs 170, network nodes, or other devices as described with reference to FIGS. 1 and 2.

In the following description of process flow 500, the operations between the UE 115-d and the network entity 105-c may be performed in a different order than the order shown, or other operations may be added or removed from the process flow 500. For example, some operations may also be omitted from the process flow 500, or may be performed in different orders or at different times. Further, although some operations or signaling may be shown to occur at different times for discussion purposes, these operations may actually occur at the same time. Although the UE 115-d and the network entity 105-c are shown performing the operations of process flow 500, some aspects of some operations may also be performed by one or more other wireless or network devices.

At 505, the UE 115-d may receive (e.g., obtain, be provided) information from the network entity 105-c differentiating a first communication during a set of active periods of a cell discontinuous operation (e.g., DTX/DRX operation) from a second communication outside of the plurality of active periods (e.g., during a non-active period of the discontinuous operations, during a non-DTX/DRX operation). In some examples, the UE 115-d may receive second information indicative of one or more RACH occasions and a set of random access preambles associated with a misdetection of an activation message or a deactivation message (e.g., an activation DCI activating the cell discontinuous operation). The cell discontinuous operation may be associated with a cycle that includes the set of active periods and a set of non-active periods. In some examples, the UE 115-d may receive a message indicating that a cell DTX/DRX configuration is a fallback cell DTX/DRX configuration.

At 510, the network entity 105-c may output (e.g., transmit, provide, send, broadcast, report) an activation message or a deactivation message associated with the cell discontinuous operation. The activation/deactivation message may be a control message (e.g., a DCI message, a group common DCI message). In some examples, the UE 115-d may fail to detect the activation/deactivation message.

At 515, the UE 115-d may report (e.g., transmit, provide, output, send), from a first layer of the UE 115-d to a second layer of the UE 115-d, a failure to receive an activation message or a deactivation message associated with a cell discontinuous operation in accordance with the information that differentiates the first communication from the second communication.

At 520, the UE 115-d may transmit (e.g., provide, output, send, report), to the network entity 105-c based on the reporting of the failure to receive the activation/deactivation message, a message indicating the failure to receive the activation/deactivation message. The UE 115-d may transmit, via the message, an indication that the cell discontinuous operation corresponds to cell DTX or cell DRX, or both. The UE 115-d may transmit, via the message, an indication of a cell DTX/DRX configuration associated with the cell discontinuous operation in accordance with a detection of the cell DTX/DRX configuration from a set of multiple DTX/DRX configurations associated with the cell discontinuous operation. In some examples, the message may indicate that the cell DTX/DRX configuration is activated at the UE 115-d. In other examples, the message may indicate that the UE 115-d will activate the cell DTX/DRX configuration at the UE 115-d after a duration (e.g., at 525-b, at 525-c). The UE 115-d may transmit the message via a PRACH, via a UCI message, or via RRC or MAC-CE (e.g., or other higher layer) signaling. The message may include a random access preamble that indicates the failure to receive the activation/deactivation message.

At 525, the UE 115-d may determine that a parameter associated with the reporting of the failure to receive the activation/deactivation message (e.g., at 515) satisfies a threshold. Determining the parameter may include one or more of incrementing a counter or starting a timer based on reporting the failure to receive the activation/deactivation message. In some examples, the UE 115-d may perform one or more measurements associated with one or more active periods of a cell DTX/DRX configuration (e.g., a hypothesis DTX/DRX configuration) and one or more second measurements associated with one or more non-active periods of the cell DTX/DRX configuration.

At 530-a, the UE 115-d may change an activation status of a cell DTX/DRX configuration at the UE 115-d based on the reporting of the failure to receive the activation/deactivation message (e.g., at 515). For example, the UE 115-d may activate (e.g., or deactivate) the cell DTX/DRX configuration at the UE 115-d. In some examples, the cell DTX/DRX configuration may be a fallback cell DTX/DRX configuration (e.g., in cases in which the cell DTX/DRX configuration is unknown).

At 535, the UE 115-d may receive (e.g., obtain, be provided), from the network entity 105-c and responsive to the message, a control message indicating the UE 115-d to activate a cell DTX/DRX configuration associated with the cell discontinuous operation. In some examples, the UE 115-d may receive the message during a random access response window based on a random access preamble that the UE 115-d transmits (e.g., at 520). At 530-b, the UE 115-d may activate the cell DTX/DRX configuration at the UE 115-d based on the control message.

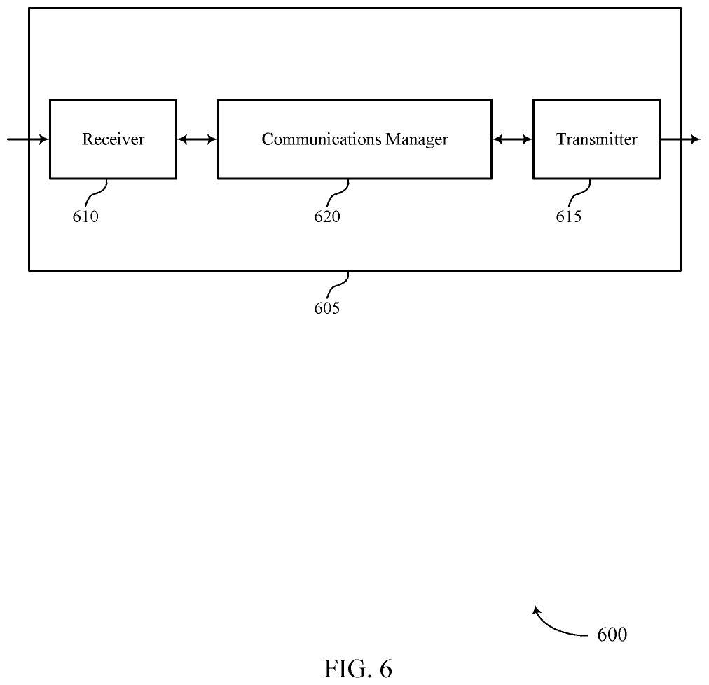

FIG. 6 shows a block diagram 600 of a device 605 that supports UE behavior based on detection of a cell discontinuous operation in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to UE behavior based on detection of a cell discontinuous operation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to UE behavior based on detection of a cell discontinuous operation). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of UE behavior based on detection of a cell discontinuous operation as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, determining, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for reporting, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods. The communications manager 620 is capable of, configured to, or operable to support a means for transmitting, to a network entity based on the reporting of the failure to receive the activation/deactivation message from the first layer to the second layer, a message indicating the failure to receive the activation/deactivation message.

Additionally, or alternatively, the communications manager 620 may support wireless communications in accordance with examples as disclosed herein. For example, the communications manager 620 is capable of, configured to, or operable to support a means for reporting, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods. The communications manager 620 is capable of, configured to, or operable to support a means for changing an activation status of a cell DTX/DRX configuration at the UE based on the reporting of the failure to receive the activation/deactivation message.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing and reduced power consumption by enabling devices (e.g., UEs, network entities) to enter a low power mode and by reducing transmissions that go undetected or unreceived by a device that is a target device for such transmissions.

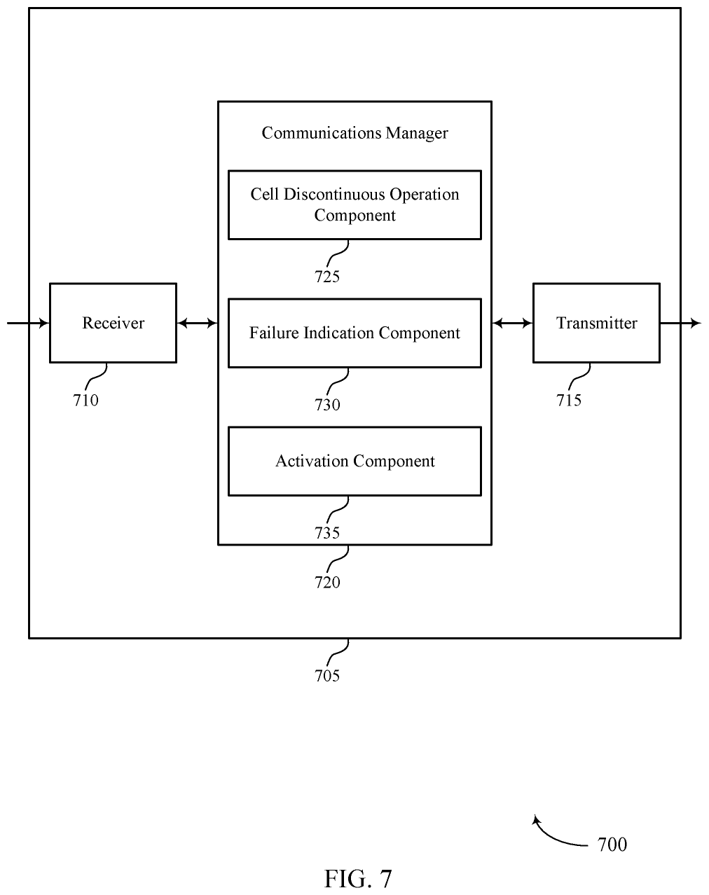

FIG. 7 shows a block diagram 700 of a device 705 that supports UE behavior based on detection of a cell discontinuous operation in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to UE behavior based on detection of a cell discontinuous operation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to UE behavior based on detection of a cell discontinuous operation). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of UE behavior based on detection of a cell discontinuous operation as described herein. For example, the communications manager 720 may include a cell discontinuous operation component 725, a failure indication component 730, an activation component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, determining, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The cell discontinuous operation component 725 is capable of, configured to, or operable to support a means for reporting, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods. The failure indication component 730 is capable of, configured to, or operable to support a means for transmitting, to a network entity based on the reporting of the failure to receive the activation/deactivation message from the first layer to the second layer, a message indicating the failure to receive the activation/deactivation message.

Additionally, or alternatively, the communications manager 720 may support wireless communications in accordance with examples as disclosed herein. The cell discontinuous operation component 725 is capable of, configured to, or operable to support a means for reporting, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods. The activation component 735 is capable of, configured to, or operable to support a means for changing an activation status of a cell DTX/DRX configuration at the UE based on the reporting of the failure to receive the activation/deactivation message.

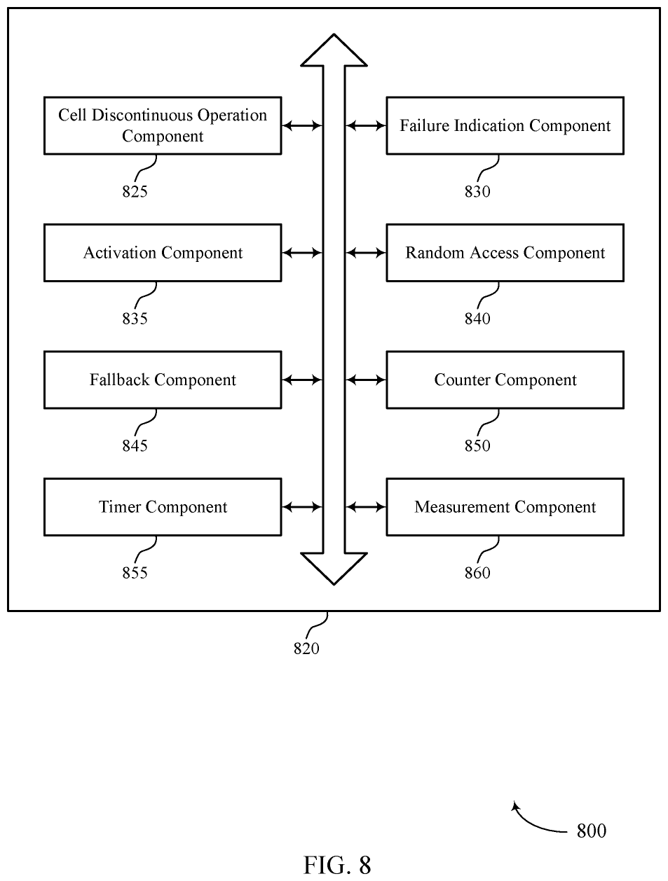

FIG. 8 shows a block diagram 800 of a communications manager 820 that supports UE behavior based on detection of a cell discontinuous operation in accordance with one or more aspects of the present disclosure. The communications manager 820 may be an example of aspects of a communications manager 620, a communications manager 720, or both, as described herein. The communications manager 820, or various components thereof, may be an example of means for performing various aspects of UE behavior based on detection of a cell discontinuous operation as described herein. For example, the communications manager 820 may include a cell discontinuous operation component 825, a failure indication component 830, an activation component 835, a random access component 840, a fallback component 845, a counter component 850, a timer component 855, a measurement component 860, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The cell discontinuous operation component 825 is capable of, configured to, or operable to support a means for reporting, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods. The failure indication component 830 is capable of, configured to, or operable to support a means for transmitting, to a network entity based on the reporting of the failure to receive the activation/deactivation message from the first layer to the second layer, a message indicating the failure to receive the activation/deactivation message.

In some examples, the failure indication component 830 is capable of, configured to, or operable to support a means for transmitting, via the message, an indication that the cell discontinuous operation corresponds to cell DTX or cell DRX, or both.

In some examples, the failure indication component 830 is capable of, configured to, or operable to support a means for transmitting, via the message, an indication of a cell DTX/DRX configuration associated with the cell discontinuous operation in accordance with a detection of the cell DTX/DRX configuration from a set of multiple cell DTX/DRX configurations associated with the cell discontinuous operation.

In some examples, the activation component 835 is capable of, configured to, or operable to support a means for activating the cell DTX/DRX configuration at the UE in accordance with transmitting the message, the message indicating that the cell DTX/DRX configuration is activated at the UE.

In some examples, the failure indication component 830 is capable of, configured to, or operable to support a means for transmitting, via the message, a second indication that the UE will activate the cell DTX/DRX configuration at the UE after a duration. In some examples, the activation component 835 is capable of, configured to, or operable to support a means for activating the cell DTX/DRX configuration at the UE after the duration.

In some examples, the activation component 835 is capable of, configured to, or operable to support a means for receiving, from the network entity and responsive to the message, a control message indicating the UE to activate a cell DTX/DRX configuration associated with the cell discontinuous operation. In some examples, the activation component 835 is capable of, configured to, or operable to support a means for activating the cell DTX/DRX configuration at the UE based on the control message.

In some examples, the random access component 840 is capable of, configured to, or operable to support a means for receiving second information indicative of one or more random access channel occasions and a set of multiple random access preambles associated with a misdetection of the activation/deactivation message. In some examples, the failure indication component 830 is capable of, configured to, or operable to support a means for transmitting the message via a random access channel occasion of the one or more random access channel occasions, the message including a preamble of the set of multiple random access preambles to indicate the failure to receive the activation/deactivation message.

In some examples, the activation component 835 is capable of, configured to, or operable to support a means for receiving, during a random access response window associated with the random access channel occasion, a control message indicating the UE to activate a cell DTX/DRX configuration based on the preamble.

In some examples, the set of multiple random access preambles include two or more groups of random access preambles, each of the two or more groups of random access preambles being indicative of a respective set of bits that indicate whether the cell discontinuous operation corresponds to DTX or DRX, that indicate a detected cell DTX/DRX configuration from a set of multiple cell DTX/DRX configurations associated with the cell discontinuous operation, or both.

In some examples, the message indicates that the cell discontinuous operation is associated with an unknown cell DTX/DRX configuration at the UE.

In some examples, the failure indication component 830 is capable of, configured to, or operable to support a means for transmitting the message via a set of resources, the set of resources corresponding to a channel state information report or an uplink configured grant.

Additionally, or alternatively, the communications manager 820 may support wireless communications in accordance with examples as disclosed herein. In some examples, the cell discontinuous operation component 825 is capable of, configured to, or operable to support a means for reporting, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods. The activation component 835 is capable of, configured to, or operable to support a means for changing an activation status of a cell DTX/DRX configuration at the UE based on the reporting of the failure to receive the activation/deactivation message.

In some examples, the fallback component 845 is capable of, configured to, or operable to support a means for receiving a message indicating the cell DTX/DRX configuration as a fallback cell DTX/DRX configuration. In some examples, the activation component 835 is capable of, configured to, or operable to support a means for activating the cell DTX/DRX configuration based on the reporting of a failure to receive the activation message and the cell DTX/DRX configuration being the fallback cell DTX/DRX configuration, the changing of the activation status including the activating of the cell DTX/DRX configuration.

In some examples, the activation component 835 is capable of, configured to, or operable to support a means for activating or deactivating the cell DTX/DRX configuration based on a parameter associated with the reporting of the failure to receive the activation/deactivation message satisfying a threshold, the changing of the activation status including the activating or the deactivating of the cell DTX/DRX configuration.

In some examples, the parameter is a counter, and the counter component 850 is capable of, configured to, or operable to support a means for incrementing the counter based on reporting the failure to receive the activation/deactivation message, the activating or the deactivating of the cell DTX/DRX configuration based on a value of the counter satisfying the threshold.

In some examples, the parameter is a timer, and the timer component 855 is capable of, configured to, or operable to support a means for starting the timer based on reporting the failure to receive the activation/deactivation message, the activating or the deactivating of the cell DTX/DRX configuration based on an expiration of the timer.

In some examples, the measurement component 860 is capable of, configured to, or operable to support a means for performing one or more first measurements associated with one or more active periods of the cell DTX/DRX configuration and one or more second measurements associated with one or more non-active periods of the cell DTX/DRX configuration, the activating or the deactivating of the cell DTX/DRX configuration based on the confidence level associated with the one or more first measurements or the one or more second measurements, or both, satisfying the threshold.

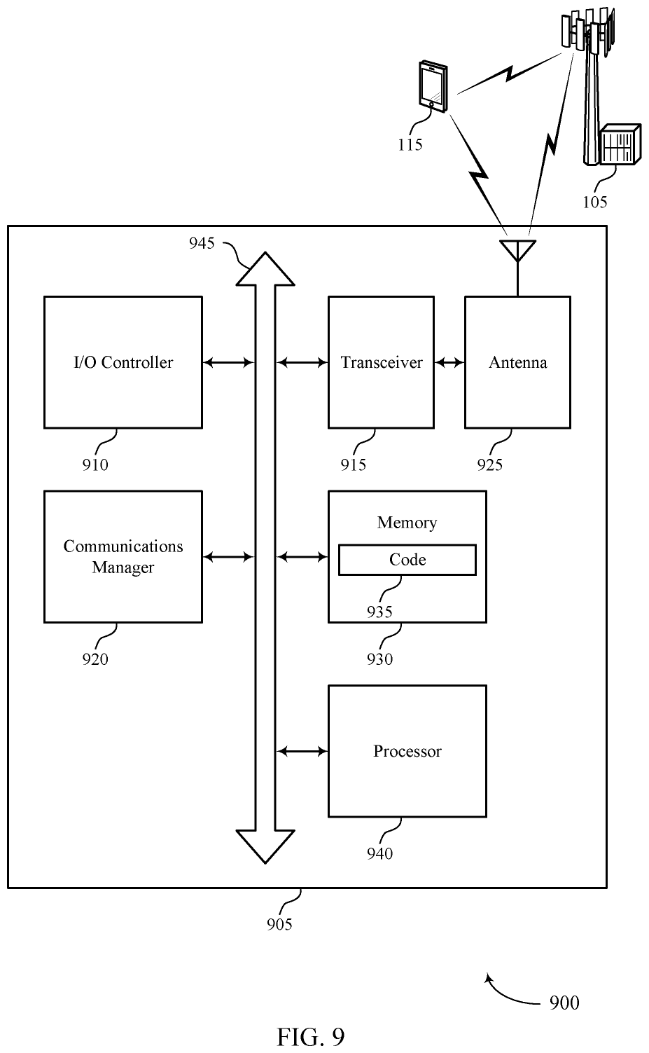

FIG. 9 shows a diagram of a system 900 including a device 905 that supports UE behavior based on detection of a cell discontinuous operation in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting UE behavior based on detection of a cell discontinuous operation). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for reporting, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods. The communications manager 920 is capable of, configured to, or operable to support a means for transmitting, to a network entity based on the reporting of the failure to receive the activation/deactivation message from the first layer to the second layer, a message indicating the failure to receive the activation/deactivation message.

Additionally, or alternatively, the communications manager 920 may support wireless communications in accordance with examples as disclosed herein. For example, the communications manager 920 is capable of, configured to, or operable to support a means for reporting, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods. The communications manager 920 is capable of, configured to, or operable to support a means for changing an activation status of a cell DTX/DRX configuration at the UE based on the reporting of the failure to receive the activation/deactivation message.

By including or configuring the communications manager 920 in accordance with examples as described herein, the device 905 may support techniques for improved communication reliability, reduced latency, reduced power consumption, and longer battery life by enabling devices (e.g., UEs, network entities) to enter a low power mode and by reducing transmissions that go undetected or unreceived by a device that is a target device for such transmissions.

In some examples, the communications manager 920 may be configured to perform various operations (e.g., receiving, monitoring, determining, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of UE behavior based on detection of a cell discontinuous operation as described herein, or the at least one processor 940 and the at least one memory 930 may be otherwise configured to, individually or collectively, perform or support such operations.

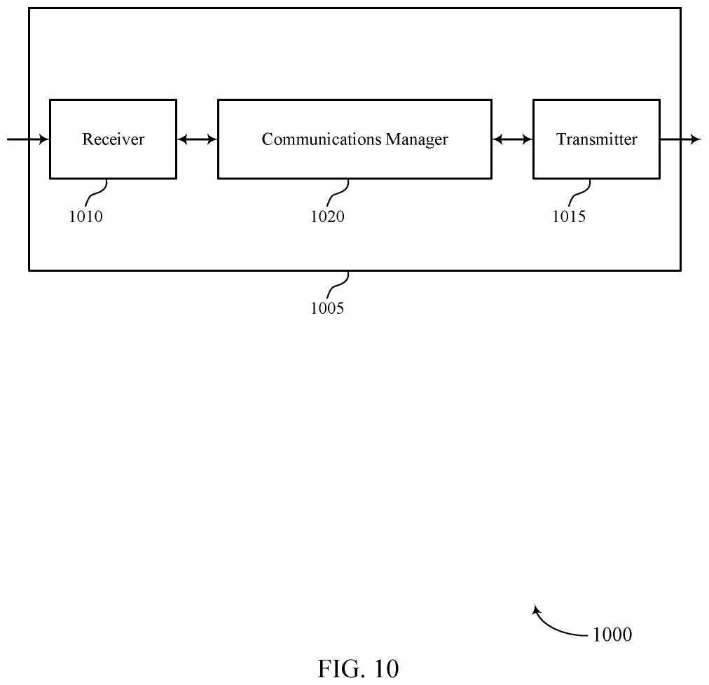

FIG. 10 shows a block diagram 1000 of a device 1005 that supports UE behavior based on detection of a cell discontinuous operation in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of UE behavior based on detection of a cell discontinuous operation as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, determining, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting one or more control messages that include information associated with whether a cell discontinuous operation is activated or deactivated, the cell discontinuous operation being associated with a cycle that includes a set of multiple active periods and a set of multiple non-active periods, the information differentiating a first communication during the set of multiple active periods from a second communication outside of the set of multiple active periods. The communications manager 1020 is capable of, configured to, or operable to support a means for outputting an activation message or a deactivation message associated with the cell discontinuous operation. The communications manager 1020 is capable of, configured to, or operable to support a means for obtaining, from a UE, a message indicating a failure by the UE to receive the activation/deactivation message.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing and reduced power consumption by enabling devices (e.g., UEs, network entities) to enter a low power mode and by reducing transmissions that go undetected or unreceived by a device that is a target device for such transmissions.

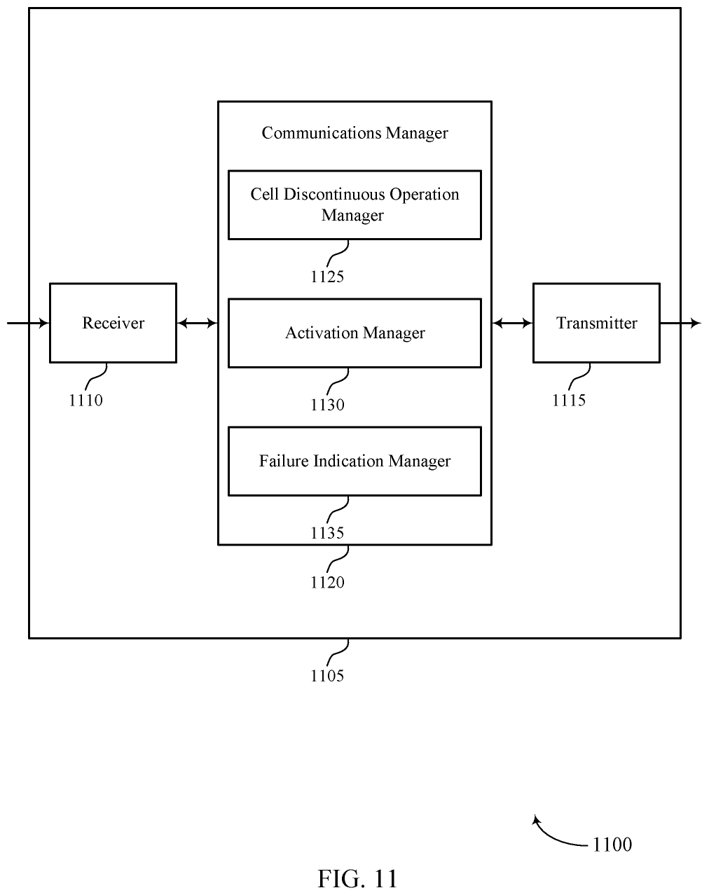

FIG. 11 shows a block diagram 1100 of a device 1105 that supports UE behavior based on detection of a cell discontinuous operation in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of UE behavior based on detection of a cell discontinuous operation as described herein. For example, the communications manager 1120 may include a cell discontinuous operation manager 1125, an activation manager 1130, a failure indication manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, determining, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The cell discontinuous operation manager 1125 is capable of, configured to, or operable to support a means for outputting one or more control messages that include information associated with whether a cell discontinuous operation is activated or deactivated, the cell discontinuous operation being associated with a cycle that includes a set of multiple active periods and a set of multiple non-active periods, the information differentiating a first communication during the set of multiple active periods from a second communication outside of the set of multiple active periods. The activation manager 1130 is capable of, configured to, or operable to support a means for outputting an activation message or a deactivation message associated with the cell discontinuous operation. The failure indication manager 1135 is capable of, configured to, or operable to support a means for obtaining, from a UE, a message indicating a failure by the UE to receive the activation/deactivation message.

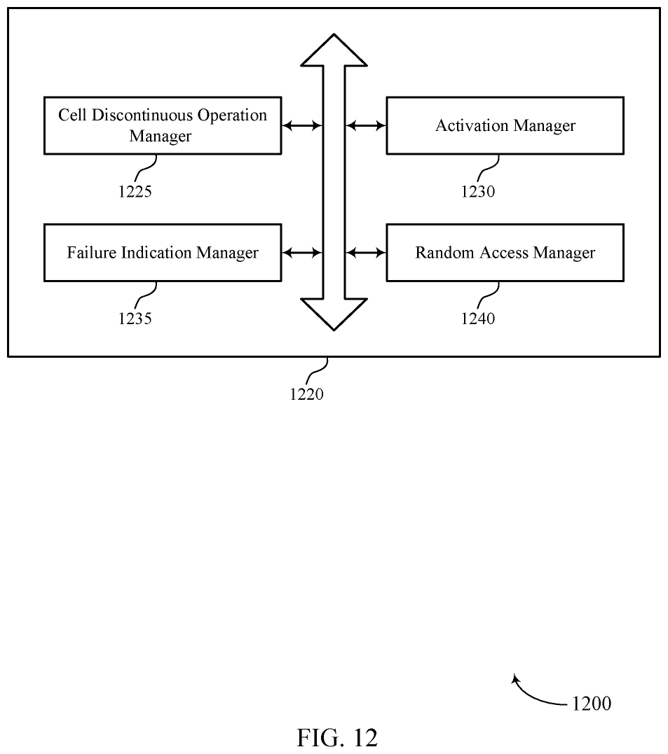

FIG. 12 shows a block diagram 1200 of a communications manager 1220 that supports UE behavior based on detection of a cell discontinuous operation in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of UE behavior based on detection of a cell discontinuous operation as described herein. For example, the communications manager 1220 may include a cell discontinuous operation manager 1225, an activation manager 1230, a failure indication manager 1235, a random access manager 1240, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The cell discontinuous operation manager 1225 is capable of, configured to, or operable to support a means for outputting one or more control messages that include information associated with whether a cell discontinuous operation is activated or deactivated, the cell discontinuous operation being associated with a cycle that includes a set of multiple active periods and a set of multiple non-active periods, the information differentiating a first communication during the set of multiple active periods from a second communication outside of the set of multiple active periods. The activation manager 1230 is capable of, configured to, or operable to support a means for outputting an activation message or a deactivation message associated with the cell discontinuous operation. The failure indication manager 1235 is capable of, configured to, or operable to support a means for obtaining, from a UE, a message indicating a failure by the UE to receive the activation/deactivation message.

In some examples, the failure indication manager 1235 is capable of, configured to, or operable to support a means for obtaining, via the message, an indication that the cell discontinuous operation corresponds to cell DTX or cell DRX, or both.

In some examples, the failure indication manager 1235 is capable of, configured to, or operable to support a means for obtaining, via the message, an indication of a cell DTX/DRX configuration associated with the cell discontinuous operation.

In some examples, the message indicates that the cell DTX/DRX configuration is activated at the UE.

In some examples, the failure indication manager 1235 is capable of, configured to, or operable to support a means for obtaining, via the message, a second indication that the UE will activate the cell DTX/DRX configuration after a duration.

In some examples, the activation manager 1230 is capable of, configured to, or operable to support a means for outputting, to the UE and responsive to the message, a control message indicating the UE to activate a cell DTX/DRX configuration associated with the cell discontinuous operation.

In some examples, the random access manager 1240 is capable of, configured to, or operable to support a means for outputting second information indicative of one or more random access channel occasions and a set of multiple random access preambles associated with a misdetection of the activation/deactivation message. In some examples, the failure indication manager 1235 is capable of, configured to, or operable to support a means for obtaining the message via a random access channel occasion of the one or more random access channel occasions, the message including a preamble of the set of multiple random access preambles to indicate the failure to receive the activation/deactivation message.

In some examples, the activation manager 1230 is capable of, configured to, or operable to support a means for outputting, during a random access response window associated with the random access channel occasion, a control message indicating the UE to activate a cell DTX/DRX configuration based on the preamble.

In some examples, the set of multiple random access preambles includes two or more groups of random access preambles, each of the two or more groups of random access preambles being indicative of a respective set of bits that indicate whether the cell discontinuous operation corresponds to DTX or DRX, that indicate a detected cell DTX/DRX configuration from a set of multiple cell DTX/DRX configurations associated with the cell discontinuous operation, or both.

In some examples, the message indicates that the cell discontinuous operation is associated with an unknown cell DTX/DRX configuration at the UE.

In some examples, to support receiving, the failure indication manager 1235 is capable of, configured to, or operable to support a means for obtaining the message via a set of resources, the set of resources corresponding to a channel state information report or an uplink configured grant.

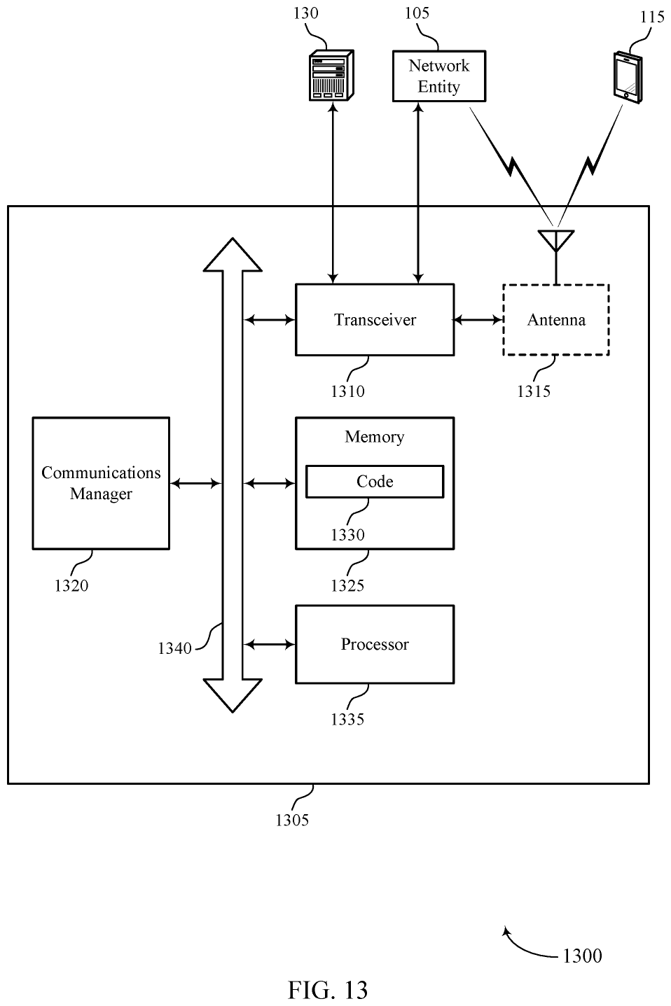

FIG. 13 shows a diagram of a system 1300 including a device 1305 that supports UE behavior based on detection of a cell discontinuous operation in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting UE behavior based on detection of a cell discontinuous operation). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. As such, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting one or more control messages that include information associated with whether a cell discontinuous operation is activated or deactivated, the cell discontinuous operation being associated with a cycle that includes a set of multiple active periods and a set of multiple non-active periods, the information differentiating a first communication during the set of multiple active periods from a second communication outside of the set of multiple active periods. The communications manager 1320 is capable of, configured to, or operable to support a means for outputting an activation message or a deactivation message associated with the cell discontinuous operation. The communications manager 1320 is capable of, configured to, or operable to support a means for obtaining, from a UE, a message indicating a failure by the UE to receive the activation/deactivation message.

By including or configuring the communications manager 1320 in accordance with examples as described herein, the device 1305 may support techniques for improved communication reliability, reduced latency, reduced power consumption, and longer battery life by enabling devices (e.g., UEs, network entities) to enter a low power mode and by reducing transmissions that go undetected or unreceived by a device that is a target device for such transmissions.

In some examples, the communications manager 1320 may be configured to perform various operations (e.g., receiving, obtaining, monitoring, determining, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of UE behavior based on detection of a cell discontinuous operation as described herein, or the at least one processor 1335 and the at least one memory 1325 may be otherwise configured to, individually or collectively, perform or support such operations.

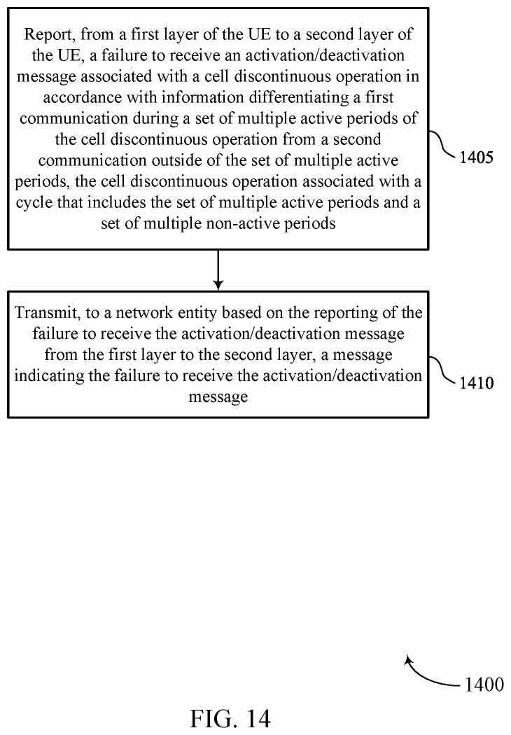

FIG. 14 shows a flowchart illustrating a method 1400 that supports UE behavior based on detection of a cell discontinuous operation in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include reporting, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods. The operations of block 1405 may be performed in accordance with examples as disclosed herein. In some examples, aspects of the operations of 1405 may be performed by a cell discontinuous operation component 825 as described with reference to FIG. 8.

At 1410, the method may include transmitting, to a network entity based on the reporting of the failure to receive the activation/deactivation message from the first layer to the second layer, a message indicating the failure to receive the activation/deactivation message. The operations of block 1410 may be performed in accordance with examples as disclosed herein. In some examples, aspects of the operations of 1410 may be performed by a failure indication component 830 as described with reference to FIG. 8.

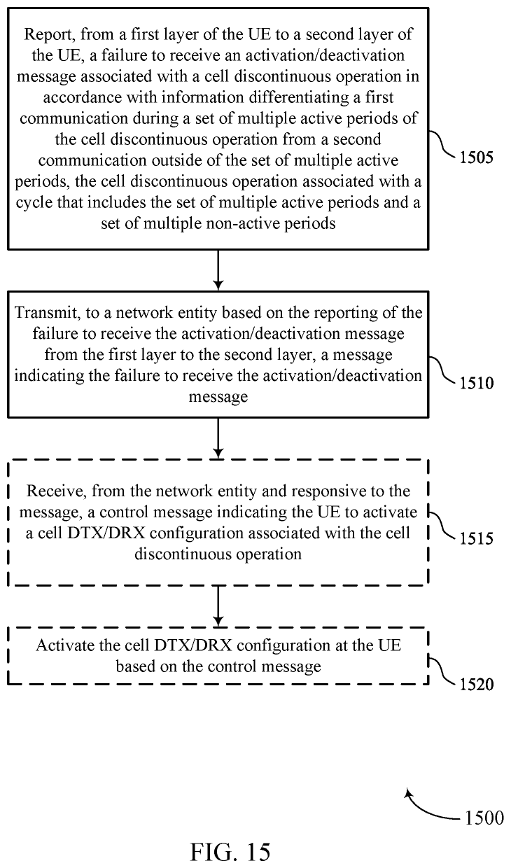

FIG. 15 shows a flowchart illustrating a method 1500 that supports UE behavior based on detection of a cell discontinuous operation in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include reporting, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods. The operations of block 1505 may be performed in accordance with examples as disclosed herein. In some examples, aspects of the operations of 1505 may be performed by a cell discontinuous operation component 825 as described with reference to FIG. 8.

At 1510, the method may include transmitting, to a network entity based on the reporting of the failure to receive the activation/deactivation message from the first layer to the second layer, a message indicating the failure to receive the activation/deactivation message. The operations of block 1510 may be performed in accordance with examples as disclosed herein. In some examples, aspects of the operations of 1510 may be performed by a failure indication component 830 as described with reference to FIG. 8.

At 1515, the method may include receiving, from the network entity and responsive to the message, a control message indicating the UE to activate a cell DTX/DRX configuration associated with the cell discontinuous operation. The operations of block 1515 may be performed in accordance with examples as disclosed herein. In some examples, aspects of the operations of 1515 may be performed by an activation component 835 as described with reference to FIG. 8.

At 1520, the method may include activating the cell DTX/DRX configuration at the UE based on the control message. The operations of block 1520 may be performed in accordance with examples as disclosed herein. In some examples, aspects of the operations of 1520 may be performed by an activation component 835 as described with reference to FIG. 8.

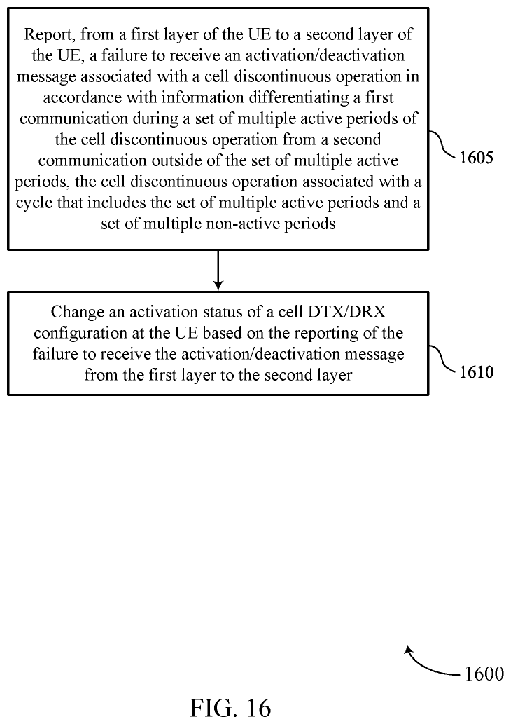

FIG. 16 shows a flowchart illustrating a method 1600 that supports UE behavior based on detection of a cell discontinuous operation in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include reporting, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods. The operations of block 1605 may be performed in accordance with examples as disclosed herein. In some examples, aspects of the operations of 1605 may be performed by a cell discontinuous operation component 825 as described with reference to FIG. 8.

At 1610, the method may include changing an activation status of a cell DTX/DRX configuration at the UE based on the reporting of the failure to receive the activation/deactivation message from the first layer to the second layer. The operations of block 1610 may be performed in accordance with examples as disclosed herein. In some examples, aspects of the operations of 1610 may be performed by an activation component 835 as described with reference to FIG. 8.

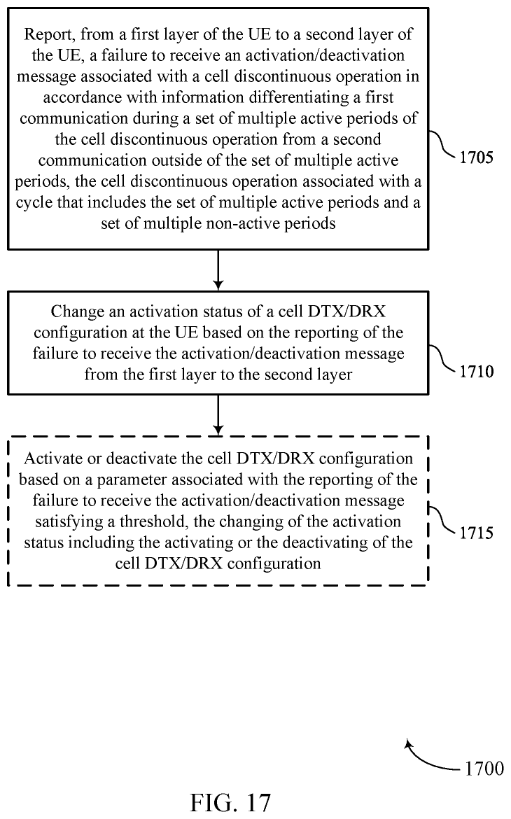

FIG. 17 shows a flowchart illustrating a method 1700 that supports UE behavior based on detection of a cell discontinuous operation in accordance with aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include reporting, from a first layer of the UE to a second layer of the UE, a failure to receive an activation message or a deactivation message associated with a cell discontinuous operation in accordance with information differentiating a first communication during a set of multiple active periods of the cell discontinuous operation from a second communication outside of the set of multiple active periods, the cell discontinuous operation associated with a cycle that includes the set of multiple active periods and a set of multiple non-active periods. The operations of block 1705 may be performed in accordance with examples as disclosed herein. In some examples, aspects of the operations of 1705 may be performed by a cell discontinuous operation component 825 as described with reference to FIG. 8.

At 1710, the method may include changing an activation status of a cell DTX/DRX configuration at the UE based on the reporting of the failure to receive the activation/deactivation message from the first layer to the second layer. The operations of block 1710 may be performed in accordance with examples as disclosed herein. In some examples, aspects of the operations of 1710 may be performed by an activation component 835 as described with reference to FIG. 8.

At 1715, the method may include activating or deactivating the cell DTX/DRX configuration based on a parameter associated with the reporting of the failure to receive the activation/deactivation message satisfying a threshold, the changing of the activation status including the activating or the deactivating of the cell DTX/DRX configuration. The operations of block 1715 may be performed in accordance with examples as disclosed herein. In some examples, aspects of the operations of 1715 may be performed by an activation component 835 as described with reference to FIG. 8.

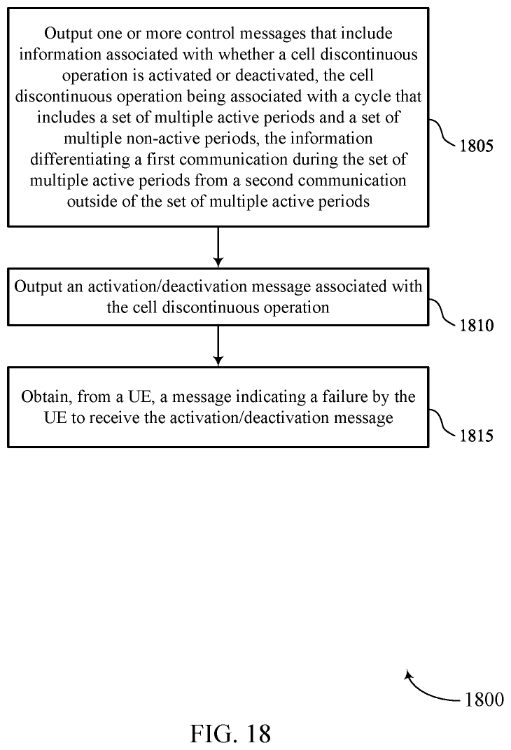

FIG. 18 shows a flowchart illustrating a method 1800 that supports UE behavior based on detection of a cell discontinuous operation in accordance with aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include outputting one or more control messages that include information associated with whether a cell discontinuous operation is activated or deactivated, the cell discontinuous operation being associated with a cycle that includes a set of multiple active periods and a set of multiple non-active periods, the information differentiating a first communication during the set of multiple active periods from a second communication outside of the set of multiple active periods. The operations of block 1805 may be performed in accordance with examples as disclosed herein. In some examples, aspects of the operations of 1805 may be performed by a cell discontinuous operation manager 1225 as described with reference to FIG. 12.

At 1810, the method may include outputting an activation message or a deactivation message associated with the cell discontinuous operation. The operations of block 1810 may be performed in accordance with examples as disclosed herein. In some examples, aspects of the operations of 1810 may be performed by an activation manager 1230 as described with reference to FIG. 12.

At 1815, the method may include obtaining, from a UE, a message indicating a failure by the UE to receive the activation/deactivation message. The operations of block 1815 may be performed in accordance with examples as disclosed herein. In some examples, aspects of the operations of 1815 may be performed by a failure indication manager 1235 as described with reference to FIG. 12.

The following provides an overview of aspects of the present disclosure:

Aspect 1: An apparatus for wireless communication at a UE, comprising: one or more memories; and one or more processors coupled with the one or more memories and configured to cause the UE to: report, from a first layer of the UE to a second layer of the UE, a failure to receive an activation message or a deactivation message associated with a cell discontinuous operation in accordance with information differentiating a first communication during a plurality of active periods of the cell discontinuous operation from a second communication outside of the plurality of active periods, the cell discontinuous operation associated with a cycle that includes the plurality of active periods and a plurality of non-active periods; and transmit, to a network entity based at least in part on the report of the failure to receive the activation message or the deactivation message from the first layer to the second layer, a message indicating the failure to receive the activation message or the deactivation message.

Aspect 2: The apparatus of aspect 1, wherein the one or more processors are configured to cause the UE to: transmit, via the message, an indication that the cell discontinuous operation corresponds to cell DTX or cell DRX, or both.

Aspect 3: The apparatus of any of aspects 1 through 2, wherein the one or more processors are configured to cause the UE to: transmit, via the message, an indication of a cell DTX/DRX configuration associated with the cell discontinuous operation in accordance with a detection of the cell DTX/DRX configuration from a plurality of cell DTX/DRX configurations associated with the cell discontinuous operation.

Aspect 4: The apparatus of aspect 3, wherein the one or more processors are configured to cause the UE to: activate the cell DTX/DRX configuration at the UE in accordance with transmission of the message, the message including a second indication that the cell DTX/DRX configuration is activated at the UE.

Aspect 5: The apparatus of any of aspects 3 through 4, wherein the one or more processors are configured to cause the UE to: transmit, via the message, a second indication that the UE will activate the cell DTX/DRX configuration at the UE after a duration; and activate the cell DTX/DRX configuration at the UE after the duration.

Aspect 6: The apparatus of any of aspects 1 through 5, wherein the one or more processors are configured to cause the UE to: receive, from the network entity and responsive to the message, a control message indicating to the UE to activate a cell DTX/DRX configuration associated with the cell discontinuous operation; and activate the cell DTX/DRX configuration at the UE based at least in part on the control message.

Aspect 7: The apparatus of any of aspects 1 through 6, wherein the one or more processors are configured to cause the UE to: receive second information indicative of one or more random access channel occasions and a plurality of random access preambles associated with a misdetection of the activation message or the deactivation message; and transmit the message via a random access channel occasion of the one or more random access channel occasions, the message including a preamble of the plurality of random access preambles to indicate the failure to receive the activation message or the deactivation message.

Aspect 8: The apparatus of aspect 7, wherein the one or more processors are configured to cause the UE to: receive, during a random access response window associated with the random access channel occasion, a control message indicating to the UE to activate a cell DTX/DRX configuration based at least in part on the preamble.

Aspect 9: The apparatus of any of aspects 7 through 8, wherein the plurality of random access preambles include two or more groups of random access preambles, each of the two or more groups of random access preambles being indicative of a respective set of bits that indicates whether the cell discontinuous operation corresponds to DTX or DRX, that indicate a detected cell DTX/DRX configuration from a plurality of cell DTX/DRX configurations associated with the cell discontinuous operation, or both.

Aspect 10: The apparatus of any of aspects 1 through 9, wherein the message indicates that the cell discontinuous operation is associated with an unknown cell DTX/DRX configuration at the UE.

Aspect 11: The apparatus of any of aspects 1 through 10, wherein to transmit the message, the one or more processors are configured to cause the UE to: transmit the message via a set of resources, the set of resources corresponding to a channel state information report or an uplink configured grant.

Aspect 12: An apparatus for wireless communication at a UE, comprising: one or more memories; and one or more processors coupled with the one or more memories and configured to cause the UE to: report, from a first layer of the UE to a second layer of the UE, a failure to receive an activation message or a deactivation message associated with a cell discontinuous operation in accordance with information differentiating a first communication during a plurality of active periods of the cell discontinuous operation from a second communication outside of the plurality of active periods, the cell discontinuous operation associated with a cycle that includes the plurality of active periods and a plurality of non-active periods; and change an activation status of a cell DTX/DRX configuration at the UE based at least in part on the report of the failure to receive the activation message or the deactivation message from the first layer to the second layer.

Aspect 13: The apparatus of aspect 12, wherein the one or more processors are configured to cause the UE to: receive a message indicating the cell DTX/DRX configuration as a fallback cell DTX/DRX configuration; and activate the cell DTX/DRX configuration based at least in part on the reporting of the failure to receive the activation message and the cell DTX/DRX configuration being the fallback cell DTX/DRX configuration, the changing of the activation status including the activating of the cell DTX/DRX configuration.

Aspect 14: The apparatus of any of aspects 12 through 13, wherein the one or more processors are configured to cause the UE to: activate or deactivate the cell DTX/DRX configuration based at least in part on a parameter associated with the reporting of the failure to receive the activation message or the deactivation message satisfying a threshold, the change of the activation status including the activation or the deactivation of the cell DTX/DRX configuration.

Aspect 15: The apparatus of aspect 14, wherein the parameter is a counter, and the one or more processors are configured to cause the UE to: increment the counter based at least in part on reporting the failure to receive the activation message or the deactivation message, the activation or the deactivation of the cell DTX/DRX configuration based at least in part on a value of the counter satisfying the threshold.

Aspect 16: The apparatus of any of aspects 14 through 15, wherein the parameter is a timer, and the one or more processors are configured to cause the UE to: start the timer based at least in part on the report of the failure to receive the activation message or the deactivation message, the activation or the deactivation of the cell DTX/DRX configuration based at least in part on an expiration of the timer.

Aspect 17: The apparatus of any of aspects 14 through 16, wherein the parameter is a confidence level, and the one or more processors are configured to cause the UE to: perform one or more first measurements associated with one or more active periods of the cell DTX/DRX configuration and one or more second measurements associated with one or more non-active periods of the cell DTX/DRX configuration, the activation or the deactivation of the cell DTX/DRX configuration based at least in part on the confidence level associated with the one or more first measurements or the one or more second measurements, or both, satisfying the threshold.

Aspect 18: An apparatus for wireless communication at a network entity, comprising: one or more memories; and one or more processors coupled with the one or more memories and configured to cause the network entity to: output one or more control messages that include information associated with whether a cell discontinuous operation is activated or deactivated, the cell discontinuous operation being associated with a cycle that includes a plurality of active periods and a plurality of non-active periods, the information differentiating a first communication during the plurality of active periods from a second communication outside of the plurality of active periods; output an activation message or a deactivation message associated with the cell discontinuous operation; and obtain, from a UE, a message indicating a failure by the UE to receive the activation message or the deactivation message.

Aspect 19: The apparatus of aspect 18, wherein the one or more processors are configured to cause the network entity to: obtain, via the message, an indication that the cell discontinuous operation corresponds to cell DTX or cell DRX, or both.

Aspect 20: The apparatus of any of aspects 18 through 19, wherein the one or more processors are configured to cause the network entity to: obtain, via the message, an indication of a cell DTX/DRX configuration associated with the cell discontinuous operation.

Aspect 21: The apparatus of aspect 20, the message including a second indication that the cell DTX/DRX configuration is activated at the UE.

Aspect 22: The apparatus of any of aspects 20 through 21, wherein the one or more processors are configured to cause the network entity to: obtain, via the message, a second indication that the UE will activate the cell DTX/DRX configuration after a duration.

Aspect 23: The apparatus of any of aspects 18 through 22, wherein the one or more processors are configured to cause the network entity to: output, to the UE and responsive to the message, a control message indicating to the UE to activate a cell DTX/DRX configuration associated with the cell discontinuous operation.

Aspect 24: The apparatus of any of aspects 18 through 23, wherein the one or more processors are configured to cause the network entity to: output second information indicative of one or more random access channel occasions and a plurality of random access preambles associated with a misdetection of the activation message or the deactivation message; and obtain the message via a random access channel occasion of the one or more random access channel occasions, the message including a preamble of the plurality of random access preambles to indicate the failure to receive the activation message or the deactivation message.

Aspect 25: The apparatus of aspect 24, wherein the one or more processors are configured to cause the network entity to: output, during a random access response window associated with the random access channel occasion, a control message indicating to the UE to activate a cell DTX/DRX configuration based at least in part on the preamble.

Aspect 26: The apparatus of any of aspects 24 through 25, wherein the plurality of random access preambles includes two or more groups of random access preambles, each of the two or more groups of random access preambles being indicative of a respective set of bits that indicates whether the cell discontinuous operation corresponds to DTX or DRX, that indicate a detected cell DTX/DRX configuration from a plurality of cell DTX/DRX configurations associated with the cell discontinuous operation, or both.

Aspect 27: The apparatus of any of aspects 18 through 26, wherein the message indicates that the cell discontinuous operation is associated with an unknown cell DTX/DRX configuration at the UE.

Aspect 28: The apparatus of any of aspects 18 through 27, wherein, to obtain the message, the one or more processors are configured to cause the network entity to: obtain the message via a set of resources, the set of resources corresponding to a channel state information report or an uplink configured grant.

Aspect 29: A method for wireless communications by a UE, comprising: reporting, from a first layer of the UE to a second layer of the UE, a failure to receive an activation message or a deactivation message associated with a cell discontinuous operation in accordance with information differentiating a first communication during a plurality of active periods of the cell discontinuous operation from a second communication outside of the plurality of active periods, the cell discontinuous operation associated with a cycle that includes the plurality of active periods and a plurality of non-active periods; and transmitting, to a network entity based at least in part on the reporting of the failure to receive the activation message or the deactivation message from the first layer to the second layer, a message indicating the failure to receive the activation message or the deactivation message.

Aspect 30: The method of aspect 29, further comprising: transmitting, via the message, an indication that the cell discontinuous operation corresponds to cell DTX or cell DRX, or both.

Aspect 31: The method of any of aspects 29 through 30, further comprising: transmitting, via the message, an indication of a cell DTX/DRX configuration associated with the cell discontinuous operation in accordance with a detection of the cell DTX/DRX configuration from a plurality of cell DTX/DRX configurations associated with the cell discontinuous operation.

Aspect 32: The method of aspect 31, further comprising: activating the cell DTX/DRX configuration at the UE in accordance with transmitting the message, the message including a second indication that the cell DTX/DRX configuration is activated at the UE.

Aspect 33: The method of any of aspects 31 through 32, further comprising: transmitting, via the message, a second indication that the UE will activate the cell DTX/DRX configuration at the UE after a duration; and activating the cell DTX/DRX configuration at the UE after the duration.

Aspect 34: The method of any of aspects 29 through 33, further comprising: receiving, from the network entity and responsive to the message, a control message indicating to the UE to activate a cell DTX/DRX configuration associated with the cell discontinuous operation; and activating the cell DTX/DRX configuration at the UE based at least in part on the control message.

Aspect 35: The method of any of aspects 29 through 34, further comprising: receiving second information indicative of one or more random access channel occasions and a plurality of random access preambles associated with a misdetection of the activation message or the deactivation message; and transmitting the message via a random access channel occasion of the one or more random access channel occasions, the message including a preamble of the plurality of random access preambles to indicate the failure to receive the activation message or the deactivation message.

Aspect 36: The method of aspect 35, further comprising: receiving, during a random access response window associated with the random access channel occasion, a control message indicating to the UE to activate a cell DTX/DRX configuration based at least in part on the preamble.

Aspect 37: The method of any of aspects 35 through 36, wherein the plurality of random access preambles include two or more groups of random access preambles, each of the two or more groups of random access preambles being indicative of a respective set of bits that indicates whether the cell discontinuous operation corresponds to DTX or DRX, that indicate a detected cell DTX/DRX configuration from a plurality of cell DTX/DRX configurations associated with the cell discontinuous operation, or both.

Aspect 38: The method of any of aspects 29 through 37, wherein the message indicates that the cell discontinuous operation is associated with an unknown cell DTX/DRX configuration at the UE.

Aspect 39: The method of any of aspects 29 through 38, wherein the transmitting comprises: transmitting the message via a set of resources, the set of resources corresponding to a channel state information report or an uplink configured grant.

Aspect 40: A method for wireless communications by a UE, comprising: reporting, from a first layer of the UE to a second layer of the UE, a failure to receive an activation message or a deactivation message associated with a cell discontinuous operation in accordance with information differentiating a first communication during a plurality of active periods of the cell discontinuous operation from a second communication outside of the plurality of active periods, the cell discontinuous operation associated with a cycle that includes the plurality of active periods and a plurality of non-active periods; and changing an activation status of a cell DTX/DRX configuration at the UE based at least in part on the reporting of the failure to receive the activation message or the deactivation message from the first layer to the second layer.

Aspect 41: The method of aspect 40, further comprising: receiving a message indicating the cell DTX/DRX configuration as a fallback cell DTX/DRX configuration; and activating the cell DTX/DRX configuration based at least in part on the reporting of the failure to receive the activation message and the cell DTX/DRX configuration being the fallback cell DTX/DRX configuration, the changing of the activation status including the activating of the cell DTX/DRX configuration.

Aspect 42: The method of any of aspects 40 through 41, further comprising: activating or deactivating the cell DTX/DRX configuration based at least in part on a parameter associated with the reporting of the failure to receive the activation message or the deactivation message satisfying a threshold, the changing of the activation status including the activating or the deactivating of the cell DTX/DRX configuration.

Aspect 43: The method of aspect 42, wherein the parameter is a counter, the method further comprising: incrementing the counter based at least in part on reporting the failure to receive the activation message or the deactivation message, the activating or the deactivating of the cell DTX/DRX configuration based at least in part on a value of the counter satisfying the threshold.

Aspect 44: The method of any of aspects 42 through 43, wherein the parameter is a timer, the method further comprising: starting the timer based at least in part on reporting the failure to receive the activation message or the deactivation message, the activating or the deactivating of the cell DTX/DRX configuration based at least in part on an expiration of the timer.

Aspect 45: The method of any of aspects 42 through 44, wherein the parameter is a confidence level, the method further comprising: performing one or more first measurements associated with one or more active periods of the cell DTX/DRX configuration and one or more second measurements associated with one or more non-active periods of the cell DTX/DRX configuration, the activating or the deactivating of the cell DTX/DRX configuration based at least in part on the confidence level associated with the one or more first measurements or the one or more second measurements, or both, satisfying the threshold.

Aspect 46: A method for wireless communications by a network entity, comprising: outputting one or more control messages that include information associated with whether a cell discontinuous operation is activated or deactivated, the cell discontinuous operation being associated with a cycle that includes a plurality of active periods and a plurality of non-active periods, the information differentiating a first communication during the plurality of active periods from a second communication outside of the plurality of active periods; outputting an activation message or a deactivation message associated with the cell discontinuous operation; and obtaining, from a UE, a message indicating a failure by the UE to receive the activation message or the deactivation message.

Aspect 47: The method of aspect 46, further comprising: obtaining, via the message, an indication that the cell discontinuous operation corresponds to cell DTX or cell DRX, or both.

Aspect 48: The method of any of aspects 46 through 47, further comprising: obtaining, via the message, an indication of a cell DTX/DRX configuration associated with the cell discontinuous operation.

Aspect 49: The method of aspect 48, the message including a second indication that the cell DTX/DRX configuration is activated at the UE.

Aspect 50: The method of any of aspects 48 through 49, further comprising: obtaining, via the message, a second indication that the UE will activate the cell DTX/DRX configuration after a duration.

Aspect 51: The method of any of aspects 46 through 50, further comprising: outputting, to the UE and responsive to the message, a control message indicating to the UE to activate a cell DTX/DRX configuration associated with the cell discontinuous operation.

Aspect 52: The method of any of aspects 46 through 51, further comprising: outputting second information indicative of one or more random access channel occasions and a plurality of random access preambles associated with a misdetection of the activation message or the deactivation message; and obtaining the message via a random access channel occasion of the one or more random access channel occasions, the message including a preamble of the plurality of random access preambles to indicate the failure to receive the activation message or the deactivation message.

Aspect 53: The method of aspect 52, further comprising: outputting, during a random access response window associated with the random access channel occasion, a control message indicating to the UE to activate a cell DTX/DRX configuration based at least in part on the preamble.

Aspect 54: The method of any of aspects 52 through 53, wherein the plurality of random access preambles includes two or more groups of random access preambles, each of the two or more groups of random access preambles being indicative of a respective set of bits that indicates whether the cell discontinuous operation corresponds to DTX or DRX, that indicate a detected cell DTX/DRX configuration from a plurality of cell DTX/DRX configurations associated with the cell discontinuous operation, or both.

Aspect 55: The method of any of aspects 46 through 54, wherein the message indicates that the cell discontinuous operation is associated with an unknown cell DTX/DRX configuration at the UE.

Aspect 56: The method of any of aspects 46 through 55, wherein the receiving comprises: obtaining the message via a set of resources, the set of resources corresponding to a channel state information report or an uplink configured grant.

Aspect 57: An apparatus for wireless communication at a UE, comprising at least one means for performing a method of any of aspects 29 through 39.

Aspect 58: A non-transitory computer-readable medium storing code for wireless communication at a UE, the code comprising instructions executable by one or more processors to cause the UE to perform a method of any of aspects 29 through 39.

Aspect 59: An apparatus for wireless communication at a UE, comprising at least one means for performing a method of any of aspects 40 through 45.

Aspect 60: A non-transitory computer-readable medium storing code for wireless communication at a UE, the code comprising instructions executable by one or more processors to cause the UE to perform a method of any of aspects 40 through 45.

Aspect 61: An apparatus for wireless communication at a network entity, comprising at least one means for performing a method of any of aspects 46 through 56.

Aspect 62: A non-transitory computer-readable medium storing code for wireless communication at a network entity, the code comprising instructions executable by one or more processors to cause the network entity to perform a method of any of aspects 46 through 56.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled with the one or more memories and configured to cause the UE to:
report, from a first layer of the UE to a second layer of the UE, a failure to receive an activation message or a deactivation message associated with a cell discontinuous operation in accordance with information that differentiates a first communication during a plurality of active periods of the cell discontinuous operation from a second communication outside of the plurality of active periods, the cell discontinuous operation associated with a cycle that includes the plurality of active periods and a plurality of non-active periods; and
transmit, to a network entity based at least in part on the report of the failure to receive the activation message or the deactivation message from the first layer to the second layer, a message that indicates the failure to receive the activation message or the deactivation message.

2. The apparatus of claim 1, the one or more processors further configured to cause the UE to:
transmit, via the message, an indication that the cell discontinuous operation corresponds to cell discontinuous transmission (DTX) or cell discontinuous reception (DRX), or both.

3. The apparatus of claim 1, the one or more processors further configured to cause the UE to:
transmit, via the message, an indication of a cell DTX or DRX (DTX/DRX) configuration associated with the cell discontinuous operation in accordance with a detection of the cell DTX/DRX configuration from a plurality of cell DTX/DRX configurations associated with the cell discontinuous operation.

4. The apparatus of claim 3, the one or more processors further configured to cause the UE to:
activate the cell DTX/DRX configuration at the UE in accordance with transmission of the message, wherein the message includes a second indication that the cell DTX/DRX configuration is activated at the UE.

5. The apparatus of claim 3, the one or more processors further configured to cause the UE to:
transmit, via the message, a second indication that the UE will activate the cell DTX/DRX configuration at the UE after a duration; and
activate the cell DTX/DRX configuration at the UE after the duration.

6. The apparatus of claim 1, the one or more processors further configured to cause the UE to:
receive, from the network entity and responsive to the message, a control message that indicates to the UE to activate a cell DTX/DRX configuration associated with the cell discontinuous operation; and
activate the cell DTX/DRX configuration at the UE based at least in part on the control message.

7. The apparatus of claim 1, the one or more processors further configured to cause the UE to:
receive second information indicative of one or more random access channel occasions and a plurality of random access preambles associated with a misdetection of the activation message or the deactivation message; and
transmit the message via a random access channel occasion of the one or more random access channel occasions, the message including a preamble of the plurality of random access preambles to indicate the failure to receive the activation message or the deactivation message.

8. The apparatus of claim 7, the one or more processors further configured to cause the UE to:
receive, during a random access response window associated with the random access channel occasion, a control message that indicates to the UE to activate a cell DTX/DRX configuration based at least in part on the preamble.

9. The apparatus of claim 7, wherein the plurality of random access preambles includes two or more groups of random access preambles, each of the two or more groups of random access preambles indicative of a respective set of bits that indicates whether the cell discontinuous operation corresponds to DTX or DRX, that indicates a detected cell DTX/DRX configuration from a plurality of cell DTX/DRX configurations associated with the cell discontinuous operation, or both.

10. The apparatus of claim 1, wherein the message includes an indication that the cell discontinuous operation is associated with an unknown cell DTX/DRX configuration at the UE.

11. The apparatus of claim 1, the one or more processors, to transmit the message, further configured to cause the UE to:
transmit the message via a set of resources, the set of resources corresponding to a channel state information report or an uplink configured grant.

12. An apparatus for wireless communication at a user equipment (UE), comprising:
one or more memories; and
one or more processors coupled with the one or more memories and configured to cause the UE to:
report, from a first layer of the UE to a second layer of the UE, a failure to receive an activation message or a deactivation message associated with a cell discontinuous operation in accordance with information that differentiates a first communication during a plurality of active periods of the cell discontinuous operation from a second communication outside of the plurality of active periods, the cell discontinuous operation associated with a cycle that includes the plurality of active periods and a plurality of non-active periods; and
change an activation status of a cell discontinuous transmission (DTX) or discontinuous reception (DRX) (DTX/DRX) configuration at the UE based at least in part on the report of the failure to receive the activation message or the deactivation message.

13. The apparatus of claim 12, the one or more processors further configured to cause the UE to:
receive a message that indicates the cell DTX/DRX configuration as a fallback cell DTX/DRX configuration; and
activate the cell DTX/DRX configuration based at least in part on the report of the failure to receive the activation message and the cell DTX/DRX configuration as the fallback cell DTX/DRX configuration, the change of the activation status including the activation of the cell DTX/DRX configuration.

14. The apparatus of claim 12, the one or more processors further configured to cause the UE to:
activate or deactivate the cell DTX/DRX configuration based at least in part on a determination that a parameter associated with the report of the failure to receive the activation message or the deactivation message satisfies a threshold, the change of the activation status including the activation or the deactivation of the cell DTX/DRX configuration.

15. The apparatus of claim 14, wherein the parameter is a counter, the one or more processors further configured to cause the UE to:
increment the counter based at least in part on the report of the failure to receive the activation message or the deactivation message, the activation or the deactivation of the cell DTX/DRX configuration based at least in part on the determination that a value of the counter satisfies the threshold.

16. The apparatus of claim 14, wherein the parameter is a timer, the one or more processors further configured to cause the UE to:
start the timer based at least in part on the report of the failure to receive the activation message or the deactivation message, the activation or the deactivation of the cell DTX/DRX configuration based at least in part on an expiration of the timer.

17. The apparatus of claim 14, wherein the parameter is a confidence level, the one or more processors further configured to cause the UE to:
perform one or more first measurements associated with one or more active periods of the cell DTX/DRX configuration and one or more second measurements associated with one or more non-active periods of the cell DTX/DRX configuration, the activation or the deactivation of the cell DTX/DRX configuration based at least in part on the determination that the confidence level associated with the one or more first measurements or the one or more second measurements, or both, satisfies the threshold.

18. A method for wireless communications by a user equipment (UE), comprising:
reporting, from a first layer of the UE to a second layer of the UE, a failure to receive an activation message or a deactivation message associated with a cell discontinuous operation in accordance with information differentiating a first communication during a plurality of active periods of the cell discontinuous operation from a second communication outside of the plurality of active periods, the cell discontinuous operation associated with a cycle that includes the plurality of active periods and a plurality of non-active periods; and
transmitting, to a network entity based at least in part on the reporting of the failure to receive the activation message or the deactivation message from the first layer to the second layer, a message indicating the failure to receive the activation message or the deactivation message.

19. The method of claim 18, further comprising:
transmitting, via the message, an indication that the cell discontinuous operation corresponds to cell discontinuous transmission (DTX) or cell discontinuous reception (DRX), or both.

20. The method of claim 18, further comprising:
transmitting, via the message, an indication of a cell DTX or DRX (DTX/DRX) configuration associated with the cell discontinuous operation in accordance with a detection of the cell DTX/DRX configuration from a plurality of cell DTX/DRX configurations associated with the cell discontinuous operation.

21. The method of claim 20, further comprising:
activating the cell DTX/DRX configuration at the UE in accordance with transmitting the message, the message including a second indication that the cell DTX/DRX configuration is activated at the UE.

22. The method of claim 20, further comprising:
transmitting, via the message, a second indication that the UE will activate the cell DTX/DRX configuration at the UE after a duration; and
activating the cell DTX/DRX configuration at the UE after the duration.

23. The method of claim 18, further comprising:
receiving, from the network entity and responsive to the message, a control message indicating to the UE to activate a cell DTX/DRX configuration associated with the cell discontinuous operation; and
activating the cell DTX/DRX configuration at the UE based at least in part on the control message.

24. The method of claim 18, further comprising:
receiving second information indicative of one or more random access channel occasions and a plurality of random access preambles associated with a misdetection of the activation message or the deactivation message; and
transmitting the message via a random access channel occasion of the one or more random access channel occasions, the message including a preamble of the plurality of random access preambles to indicate the failure to receive the activation message or the deactivation message.

25. A method for wireless communications by a user equipment (UE), comprising:
reporting, from a first layer of the UE to a second layer of the UE, a failure to receive an activation message or a deactivation message associated with a cell discontinuous operation in accordance with information differentiating a first communication during a plurality of active periods of the cell discontinuous operation from a second communication outside of the plurality of active periods, the cell discontinuous operation associated with a cycle that includes the plurality of active periods and a plurality of non-active periods; and
changing an activation status of a cell discontinuous transmission (DTX) or discontinuous reception (DRX) (DTX/DRX) configuration at the UE based at least in part on the reporting of the failure to receive the activation message or the deactivation message from the first layer to the second layer.

26. The method of claim 25, further comprising:
receiving a message indicating the cell DTX/DRX configuration as a fallback cell DTX/DRX configuration; and
activating the cell DTX/DRX configuration based at least in part on the reporting of a failure to receive the activation message and the cell DTX/DRX configuration being the fallback cell DTX/DRX configuration, the changing of the activation status including the activating of the cell DTX/DRX configuration.

27. The method of claim 25, further comprising:
activating or deactivating the cell DTX/DRX configuration based at least in part on a parameter associated with the reporting of the failure to receive the activation message or the deactivation message satisfying a threshold, the changing of the activation status including the activating or the deactivating of the cell DTX/DRX configuration.

28. The method of claim 27, the parameter being a counter, the method further comprising:
incrementing the counter based at least in part on reporting the failure to receive the activation message or the deactivation message, the activating or the deactivating of the cell DTX/DRX configuration based at least in part on a value of the counter satisfying the threshold.

29. The method of claim 27, the parameter being a timer, the method further comprising:
starting the timer based at least in part on reporting the failure to receive the activation message or the deactivation message, the activating or the deactivating of the cell DTX/DRX configuration based at least in part on an expiration of the timer.

30. The method of claim 27, the parameter being a confidence level, further comprising:
performing one or more first measurements associated with one or more active periods of the cell DTX/DRX configuration and one or more second measurements associated with one or more non-active periods of the cell DTX/DRX configuration, the activating or the deactivating of the cell DTX/DRX configuration based at least in part on the confidence level associated with the one or more first measurements or the one or more second measurements, or both, satisfying the threshold.
